(19) United States
(12) Patent Application Publication
(10) Pub. No.: US 2026/0164292 A1
(43) Pub. Date: Jun. 11, 2026

(54) A SYSTEM AND METHOD FOR ROUTING MANAGEMENT

(71) Applicant: RAKUTEN SYMPHONY, INC., Tokyo (JP)

(72) Inventor: Sridhar BHASKARAN, Tokyo (JP)

(73) Assignee: RAKUTEN SYMPHONY, INC., Tokyo (JP)

(21) Appl. No.: 18/702,069

(22) PCT Filed: Feb. 20, 2024
(86) PCT No.: PCT/US2024/016464

§ 371 Date: Apr. 17, 2024

(30) Foreign Application Priority Data
Dec. 5, 2023 (IN) 202341082775

(51) Int. Cl. H04W 28/02; H04W 40/12

(52) U.S. Cl. CPC H04W 28/0263; H04W 40/12

(57) ABSTRACT

Embodiments relate to a Control Plane System (CPS) of a Radio Access Network (RAN) node. The CPS is configured to detect a Protocol Data Unit (PDU) session established between a User Equipment (UE) and a data network and generate a session establishment request, based on the detection. The session establishment request comprises a first information element (IE) to create a Packet Detection Rule (PDR) to classify one or more IP packets received from a data network addressed to the UE as Down Link (DL) packets and a second IE to create a plurality of Forward Action corresponding to the PDR to route the DL packets from a User Plane System (UPS) to the UE through a Data Radio Bearer. The CPS is further configured to transmit the session establishment request to the UPS to facilitate the UPS to route the downlink packets to the UE through the DRB.

### CROSS-REFERENCE TO RELATED APPLICATION(S)

This application claims the benefit of Indian Provisional Application No 202341082775, entitled “METHOD TO SPECIFY PACKET CLASSIFIER AND MAPPING OF CLASSIFIED PACKET TO RADIO BEARER AT RADIO ACCESS NETWORK USING PFCP PROTOCOL” and filed on Dec. 5, 2023, which is expressly incorporated by reference herein in its entirety.

### TECHNICAL FIELD

The present disclosure generally relates to mobile communication technologies, and more specifically, to packet routing between a network entity and a User Equipment (UE).

### BACKGROUND

Mobile communication systems have been evolving every day and second to provide efficient and reliable communication services to users. There are several types of communication services for mobile networks, including enhanced Mobile Broadband (eMBB), massive Machine Type Communication (mMTC) and Ultra-Reliable Low Latency Communication (uRLLC). User Equipments (UEs) may request a mobile network to provision one of the communication service types during registration of the UEs. Accordingly, if a UE registers for uRLLC services, the mobile network needs to provide communication services with extremely low latencies, such as, less than 1 millisecond with high reliability. In addition, some UEs may also be associated with low mobility. For example, such UEs may be Industrial Internet of Things (IIoT) devices with limited mobility.

Further, when the UE needs to communicate with one or more Data Networks (DNs) to receive or send data, the UE may communicate through one or more network entities, such as a User Plane Function (UPF), a Session Management Function (SMF) and Radio Access Network (RAN) node entities, such as RAN Central Unit-Control Plane (CU-CP) and RAN Central Unit-User Plane (CU-UP).

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In general, the data communication between the UE and the DN involves one or more headers to be included in packets transmitted between each of the network entities, such as the DN, the UPF, the RAN CU-CP and the RAN CU-UP before reaching the UE in downlink transmission and the DN in the uplink transmission. For example, the UPF may include one or more headers, such as, a General Packet Radio Service (GPRS) Tunnelling Protocol-User Plane (GTP-U) header, a User Datagram Protocol (UDP) header, and an outer Internet Protocol (IP) of GTP-U tunnel header to route packet data between the UE and the DN. Such requirement of headers results in more time consumed by a network entity to add the one or more headers and by another network entity to remove the one or more headers. In some scenarios, such as, but not limited to, for low mobility UEs which require low latency services, embedding and removal of headers in the packet data may introduce unnecessary latency, which can be mitigated. The present disclosure provides a control plane system and a user plane system to solve one or more problems mentioned above.

In an embodiment, the present disclosure relates to a control plane system of a Radio Access Network (RAN) node. The control plane system is configured to detect a Protocol Data Unit (PDU) session established between a User Equipment (UE) and a Data Network (DN) and generate a session establishment request, based on the detection, to establish a Packet Forwarding Control Protocol (PFCP) session context in a user plane system. The session establishment request comprising a first information element to create a Packet Detection Rule (PDR) to classify one or more IP packets received from the DN addressed to the UE as downlink packets and a second information element to create a plurality of Forward Action Rules (FARs) corresponding to the PDR to route the downlink packets from the user plane system to the UE through a Data Radio Bearer (DRB). The control plane system is further configured to transmit the session establishment request to the user plane system to facilitate the user plane system to route the downlink packets to the UE through the DRB.

In another embodiment, the present disclosure relates to a user plane system of a RAN node, that is configured to establish a Protocol Data Unit (PDU) session between a User Equipment (UE) and a Data Network (DN) and receive a session establishment request from the control plane system in response to the establishment. The user plane system is configured to install a Packet Detection Rule (PDR) to classify one or more IP packets as downlink packets received from the DN addressed to the UE using a first information element received in the session establishment request and install a plurality of Forward Action Rules (FARs) corresponding to the PDR using a second information element in the session establishment request to route the downlink packets through a Data Radio Bearer (DRB). The user plane system is further configured to route the downlink packets to the UE through the DRB.

In yet another embodiment, the present disclosure relates to a user plane system of a Radio Access Network (RAN) node, that is configured to establish a Protocol Data Unit (PDU) session between a User Equipment (UE) and a Data Network (DN) and receive a session establishment request from the control plane system in response to the establishment. The user plane system is configured to install a Packet Detection Rule (PDR) to classify one or more IP packets received from a RAN Distributed Unit (DU) as one of one or more uplink data packets using a first information element received in the session establishment request or one or more uplink control packets using a second information element received in the session establishment request. The user plane system is further configured to remove an outer header of the one or more uplink data packets using a third information element received in the session establishment request. The outer header comprises at least a tunnelling extension header, a Packet Data Convergence Protocol (PDCP) header, and a Service Data Adaptation Protocol (SDAP) header. The user plane system is further configured to route the one or more uplink data packets to the DN. The user plane system is also configured to determine one or more predefined rules associated with the one or more uplink control packets using a fourth information element in the session establishment request and route the one or more uplink control packets based on the one or more predefined rules.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference features and components. Some embodiments of device and/or methods in accordance with embodiments of the present subject matter are now described, by way of example only, and with reference to the accompanying figures, in which:

FIG. 1a and FIG. 1b illustrate one or more components of an existing mobile network architecture, where some embodiments of the present disclosure may be practiced;

FIG. 2 illustrates an exemplary architecture for routing management in accordance with an embodiment of the present disclosure;

FIG. 3 illustrates an exemplary block diagram of a Control Plane System (CPS) for downlink routing management in accordance with an embodiment of the present disclosure;

FIG. 4 illustrates an exemplary block diagram of a User Plane System (UPS) for downlink routing management, in accordance with an embodiment of the present disclosure;

FIG. 5 illustrates an exemplary flowchart of a method for downlink routing management performed by the CPS in accordance with another embodiment of the present disclosure;

FIGS. 6a and 6b illustrate exemplary flowcharts of methods for downlink routing management performed by the UPS in accordance with another embodiment of the present disclosure;

FIG. 7a illustrates an exemplary block diagram of a CPS for uplink routing management in accordance with an embodiment of the present disclosure;

FIG. 7b illustrates a format for the GTP-U extension header and command for uplink routing management in accordance with an embodiment of the present disclosure;

FIG. 8 illustrates an exemplary block diagram of a UPS for uplink routing management, in accordance with an embodiment of the present disclosure;

FIG. 9 illustrates an exemplary flowchart of a method for uplink routing management performed by the CPS in accordance with another embodiment of the present disclosure; and

FIG. 10 illustrates an exemplary flowchart of a method for uplink routing management performed by the UPS in accordance with another embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to methods and systems for routing data between a data Network (DN) and a UE through a Data Radio Bearer (DRB) assigned to the UE. The present disclosure provides a Control Plane System (CPS) that provisions one or more rules to a User Plane System (UPS) that enable the UPS to route the data between the DN and the UE for achieving improved low latency services to UEs, especially to the UEs which are associated with low mobility. The present disclosure provides the CPS comprising, SMF and RAN CU-CP, for determining a location of a UE when the UE is in one of RRC_INACTIVE or RRC_IDLE states. The CPS pages the UE upon receiving a downlink data notification from the UPS. The present disclosure also addresses various limitations of the UPS for sending the downlink data notification to the CPS of the UEs in RRC_INACTIVE or RRC_IDLE states. Thus, the present disclosure eliminates the need for sending two different downlink data notifications to two different entities, such as SMF and RAN CU-CP. The present disclosure also discloses aspects related to a network interface established between the UPS and the CPS, wherein the UPS receives location of the UE upon successful paging from the CPS.

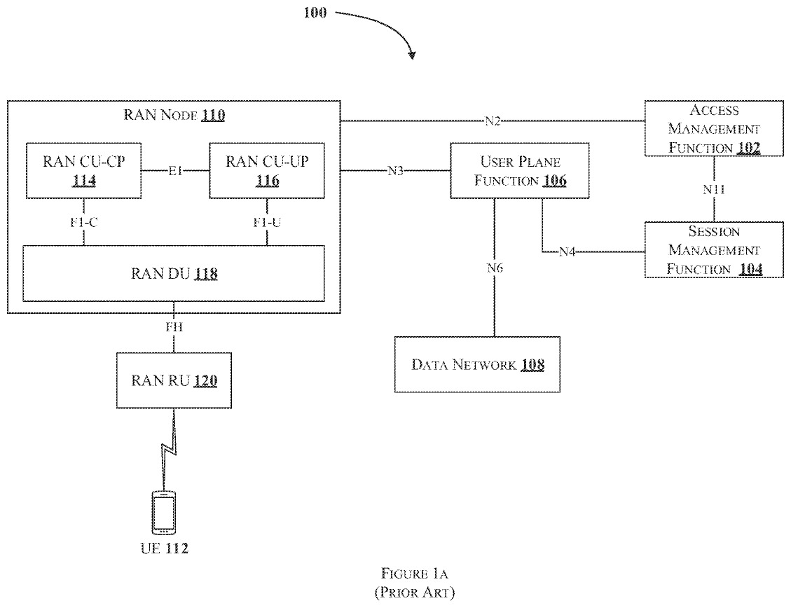

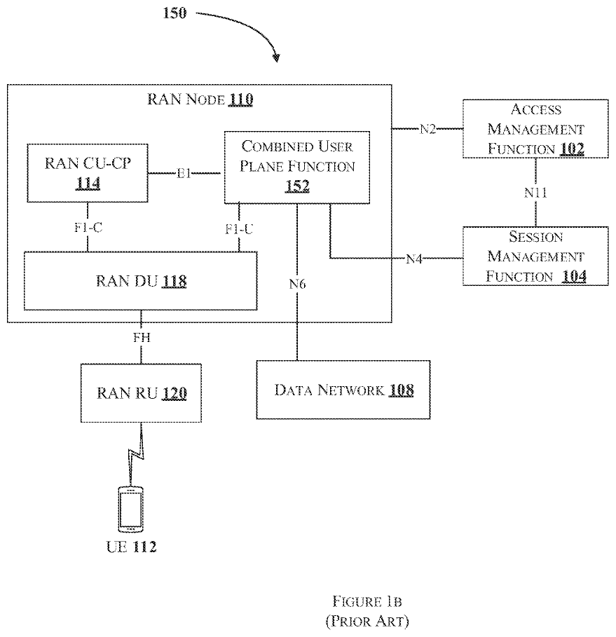

FIG. 1a illustrates one or more components of an existing mobile network architecture, where some embodiments of the present disclosure may be practiced.

As shown in FIG. 1a, the mobile network architecture 100 may comprise one or more components such as, but not limited to, an Access and Mobility management Function (AMF) 102, a Session Management Function (SMF) 104, a User Plane Function (UPF) 106, a Data Network (DN) 108, and a RAN node 110 providing communication services to a User Equipment (UE) 112. The one or more components of the mobile network architecture 100, hereinafter referred to as, the architecture 100, may correspond to a mobile network to provide the communication services. In some embodiments, the architecture 100 may be a 5^{th} Generation (5G) network architecture as specified by 3^{rd} Generation Partnership Project (3GPP) standard. Further, the RAN node 110 may be a disaggregated RAN node comprising at least a RAN Centralized Unit-Control Plane (CU-CP) 114, RAN CU-User Plane (CU-UP) 116, a RAN Distributed Unit (DU) 118 and a RAN Radio Unit (RU) 120. The one or more components 102-120 of the architecture 100 may perform one or more functions specified by the 3GPP standard and these functionalities are not explained herein for the sake of brevity. In addition to the one or more components depicted in FIG. 1a, the architecture 100 may also comprise one or more other components of 5G system architecture specified by the 3GPP standard.

Further, the components 102-110 and 114-118 may be communicating with one another via one or more interfaces as specified in 3GPP standard. Accordingly, the RAN node 110 may communicate with AMF 102 through an N2 interface and communicate with the UPF 106 through an N3 interface. The UPF 106 may communicate with the SMF 104 through an N4 interface and communicate with the DN 108 through an N6 interface. Further, the SMF 104 may communicate with the AMF 102 through an N11 interface. Furthermore, the RAN CU-CP 114 may communicate with the RAN CU-UP 116 through an E1 interface, the RAN DU 118 may communicate with the RAN CU-UP 116 through an F1-U interface, and with the RAN CU-CP 114 through an F1-C interface. The RAN DU 118 and RAN RU 120 may communicate with each other through an FH interface and the RAN RU 120 may communicate with the UE 112 through one or more physical interfaces such as one or more radio channels specified in 3GPP standards. It shall be noted that the N1, N2, N4, N6, N11, E1, F1-U and F1-C interfaces mentioned above are standard interfaces defined in 3GPP standard to provide communication between corresponding components 102-118 for each interface.

The UE 112 may be any computing device configured to communicate with one or more components of the architecture 100 through the RAN RU 120. As an example, the UE 112 may be a mobile phone, a smartphone, a laptop, a notepad, electronic gadgets such as a smart watch etc., Internet of Things (IoT) based devices, and the like with 5G communication capabilities and configured to communicate and/or access data from the DN 108 through one or more components of the architecture 100. As such, in one example, the UE 112 may be configured to connect to the DN 108, through one or more components of the architecture 100. The DN 108 may provide various types of data such as, but not limited to, video data, audio data and/or any other data.

The DN 108 may be any type of third-party services communicating with the UPF 106 of the architecture 100 to provide services to one or more UEs, for e.g., the UE 112. For example, the DN 108 may be an Internet services Provider (ISP). In another example, the DN 108 may be providing video data service, audio data service or other data available over the Internet.

Conventionally, the UE 112 may request the AMF 102 through the RAN node 110 to establish a Protocol Data Unit (PDU) session for receiving one or more data from the DN 108. The request may include a plurality of parameters including at least a type of service required for the UE 112 such as, but not limited to, a uRLLC service. In response, the AMF 102 may select an SMF, such as, but not limited to, the SMF 104, based on a plurality of parameters including the type of service. Further, the AMF 102 may create a Session Management (SM) context for the PDU session in the SMF 104. The SMF 104 may be responsible for interacting with a UPF, for e.g., the UPF 106 to perform one or more of creating, updating, and removing PDU sessions and managing session context with the UPF, for e.g., the UPF 106.

The SMF 104 may further select the UPF 106, based on a plurality of parameters including, but not limited to, the requested data, a location of the UE 112, the type of service, an identifier of the DN 108. The SMF 104 may establish a user plane session context required for establishing the PDU session in the UPF 106. The user plane session context may include, but not limited to, one or more Packet Detection Rules (PDRs), a plurality of Forward Action Rules (FARs), one or more Usage Reporting Rules (URRs) and a plurality of Quality of Service (QoS) Enforcement Rules (QERs) associated with the one or more PDRs for the PDU session. Further, the UPF 106 may establish the PDU session between the UE 112 and the DN 108 based on the request, receive the user plane session context from the SMF 104, and store the one or more rules to route downlink data in the PDU session. The UPF 106 may be responsible for receiving downlink data from the DN 108 and forward the downlink data based on the one or more rules through the PDU session. The UPF 106 may also be configured to provide one or more usage records for a plurality of UEs to the SMF 104 separately for each UE 112. It may be appreciated that the user plane session context may comprise one or more rules to route uplink data from the UE 112 to the DN 108.

Upon initiating the PDU session, the UPF 106 may receive downlink data comprising a plurality of Internet Protocol (IP) packets from the DN 108. The UPF 106 may further route each IP packet within the PDU session in a General Packet Radio Service (GPRS) Tunnelling Protocol-User Plane (GTP-U) tunnel through the N3 interface to the RAN CU-UP 116. Further, the UPF 106 may add one or more headers such as, but not limited to, GTP-U header, a User Datagram Protocol (UDP) header, and an outer IP of GTP-U tunnel header. The UPF 106 may encapsulate the received IP packet by adding one or more headers and may route the encapsulated IP packet to the RAN CU-UP 116 through a GTP-U tunnel. The RAN CU-UP 116 may receive the encapsulated IP packet, remove the one or more headers added by the UPF 106 and may further encapsulate the IP packet by adding one or more other headers (e.g., adding PDCP, SDAP headers and F1-U GTP/UDP/IP headers). Thereafter, the RAN CU-UP 116 may route the encapsulated IP packet to the UE 112 through the RAN DU 118 and the RAN RU 120.

Thus, the routing of the IP packets through the GTP-U tunnel may facilitate mobility and bearer QoS enforcement within the GTP-U tunnel. Particularly, when the UE 112 is highly mobile between multiple RAN RUs 120/RAN DUs/RAN CU-UPs, the UPF 106 may remain at a same location while the GTP-U tunnel may be switched from a source RAN DU/CU-UP to a target RAN DU/CU-UP. However, for UEs that require low latency services such as, uRLLC services, and when the UEs have limited mobility, the UPF 106 may be collocated at the RAN CU-UP 116 to avoid the N3 interface GTP-U tunnelling and thereby avoid adding the one or more headers associated with the GTP-U tunnelling. The architecture of the UPF 106 collocated at the RAN CU-UP 116 is explained further in FIG. 1b.

FIG. 1b illustrates one or more components of an existing mobile network architecture, where some embodiments of the present disclosure may be implemented.

As shown in FIG. 1b, the architecture 150 comprises a Combined User Plane Function (CUPF) 152 that combines the RAN CU-UP 116 and the UPF 106 located at the RAN node 110. In scenarios where the UE 112 satisfies one or more unification criteria, the SMF 104 may select the CUPF 152 to establish a PDU session between the UE 112 and the DN 108. The one or more unification criteria may include, but not limited to, low latency services and low mobility services. As shown in FIG. 1b, selecting the CUPF 152 may avoid tunneling between the RAN CU-UP 116 and UPF 106 and hence reduce overhead to be included on the IP packet at the UPF 106. Further, the other components of the architecture 150 may interact with the CUPF 152 as with individual components RAN CU-UP 116 and the UPF 106, as described in the architecture 100.

A problem envisaged in the architecture 150 may be establishing PDU sessions with the UE 112 when the UE 112 is in one of RRC_INACTIVE state or RRC_IDLE state. When the CUPF 152 receives downlink data from the DN 108 and when the UE 112 is in one of RRC_INACTIVE state or RRC_IDLE state, the CUPF 152 needs to initially locate the UE 112 in order to route the downlink data to the UE 112. However, the CUPF 152 may not have the details of the UE 112, such as, but not limited to, identification details of the RAN DU 120 associated with the UE 112 to communicate with the UE 112. Hence, the CUPF 152 may communicate with the RAN CU-CP 114 or SMF 104 to locate the UE 112. In an embodiment, the CUPF 152 may communicate with the RAN CU-CP 114 when the UE 112 is in RRC_INACTIVE state and the SMF 104 when the UE 112 is in RRC_IDLE state. Thus, even though the CUPF 152 achieves the combined functionality of the UPF 106 and the RAN CU-UP 116, the CUPF 152 still requires two separate hardware modules to request two types of paging. This increases hardware complexity at the CUPF 152.

Another problem envisaged in the architecture 150 may occur when the CUPF 152 is communicating with two control plane functions through two different interfaces at the same time. In other words, the CUPF 152 communicates with the SMF 104 through the N4 interface and simultaneously with the RAN CU-CP 114 through the E1 interface. However, to remove the GTP-U tunneling and directly forward the downlink data received on N6 interface to the RAN DU 118 through the F1-U interface, the SMF 104 needs to generate rules to remove the GTP-U tunneling and include Service Data Adaptation Protocol (SDAP) and Packet Data Convergence Protocol (PDCP) configuration. However, the SDAP and the PDCP configuration data need to be included in a communication occurring through the E1 interface. Thus, sending data of the E1 interface through the N4 interface may lead to cross functional spillage, which may lead to unnecessary complexities.

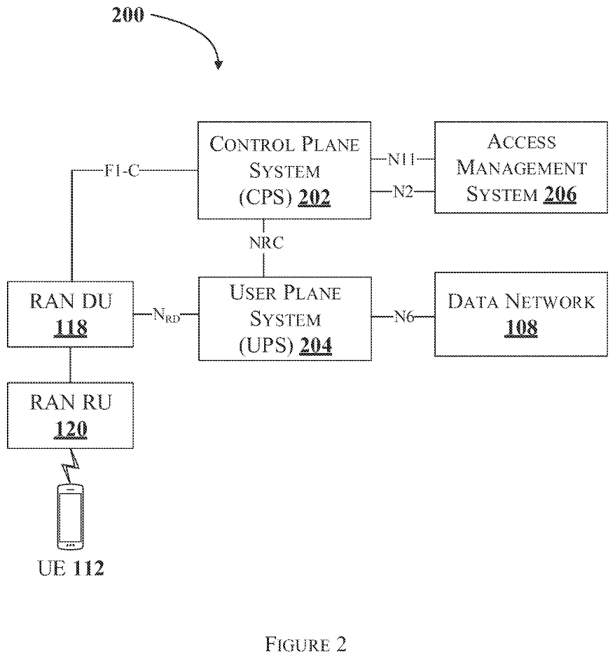

FIG. 2 illustrates an exemplary architecture for routing management in accordance with an embodiment of the present disclosure.

As shown in FIG. 2, the architecture 200 may comprise one or more components to route data between the DN 108 and the UE 112, when the UE 112 is associated with low latency and low mobility services. Accordingly, the present disclosure relates to providing a control plane architecture, herein after referred to as, a Control plane system (CPS) 202, for collocating the SMF 104 at the RAN CU-CP 114 to provide efficient routing of data between the DN 108 and the UE 112. Further, the present disclosure relates to providing methods for communication between the CPS 202 and a CUPF (hereinafter referred to as a User Plane System (UPS) 204) for the routing. The present disclosure also relates to providing an AMF (also hereinafter referred to as an Access Management System (AMS) 206, that communicates with the CPS 202. Furthermore, the present disclosure relates to providing a network interface (hereinafter referred to as N_{RC}) to facilitate communication between the CPS 202 and the UPS 204.

The architecture 200 may comprise the CPS 202, the UPS 204, and the AMS 206 to efficiently route data between the DN 108 and the UE 112 through the RAN DU 118 and RAN RU 120. In some embodiments, the CPS 202 and the UPS 204 may be configured within the RAN node 110. In some embodiments, the UPS 204 may be the CUPF 152 of FIG. 1b configured to perform one or more methods disclosed in the present disclosure. In some embodiments, the AMS 206 may be the AMF 102 of FIG. 1b configured to perform one or more methods disclosed in the present disclosure.

The UPS 204 may communicate with the DN 108 over the N6 interface. The UPS 204 may communicate with the CPS 202 through the N_{RC} interface. The N_{RC} interface may be configured to communicate using Packet Forwarding Control Protocol (PFCP). The UPS 204 may communicate with the RAN DU 118 through an NRD interface. The NRD interface may be one of a F1-U interface or User Datagram Protocol (UDP) tunnelling over Internet Protocol v6 (IPv6). In some embodiments, the UPS 204 may be deployed proximate to the UE 112 to avoid any tunneling requirements to route the data of the UE 112 between the UE 112 and the DN 108. In some embodiments, the UPS 204 may be configured to provide one or more inline IP services such as, but not limited to, firewall, Network Address Translation (NAT), intrusion prevention systems, HyperText Transfer Protocol (HTTP) header enrichment and the like.

The DN 108 of FIG. 2 may be configured to provide Service Function Chaining (SFC) where each service is realized as a virtualized function in edge cloud.

Further, the CPS 202 may be configured to perform one or more functions of the SMF 104, and the RAN CU-CP 114 of the architectures as illustrated in FIGS. 1a and 1b. The CPS 202 may communicate with the AMS 206 through one or more of the N11 interface and N2 interface and may communicate with the RAN DU 118 through the F1-C interface.

Thus, the architecture 200 provides efficient and reliable low latency services to the UE 112 by collocating the SMF 104 and the RAN CU-CP 114 in the CPS 202 closer to the UE 112. Especially, when the UE 112 is associated with limited mobility, such an architecture 200 may facilitate providing faster communication services to the UE 112. Furthermore, the UPS 204 interacts with only one entity such as the CPS 202 for two types of paging of the UE 112, instead of performing two types of paging through two different entities, that is, the SMF 104 and the RAN CU-CP 114.

Thus, the architecture 200 reduces hardware complexity at the UPS 204 and the communication complexity from UPS 204 to RAN CU-CP 114 and SMF 104, for example, by eliminating the need to maintain two different hardware modules and two different communication paths to communicate with the two entities. Furthermore, UEs that do not require mobility across large areas may have an IP address of the UE 112 anchored at the UPS 152 and avoid any tunnelling function. Further, the architecture 200 also reduces overhead in routing downlink and/or uplink packets due to the elimination of GTP-U tunnelling and thereby avoiding inclusion of GTP-U tunnelling headers.

Further, the UPS 204 may route data related to the UE 112 between the DN 108 and the UE 112. To perform the routing, the UPS 204 may be configured with one or more rules for routing of data between the DN 108 and the UE 112 by the CPS 202. Specifically, there is a need to specify one or more rules for routing downlink data received from the DN 108 on to the DRB assigned to the UE 112. Alternatively, there is also a need to specify one or more rules for routing uplink data received from the UE 112 through the DRB to the DN 108. Configuration of such one or more rules by the CPS 202 into the UPS 204 using the PFCP is explained in detail below.

### Methods and Systems for Downlink Routing

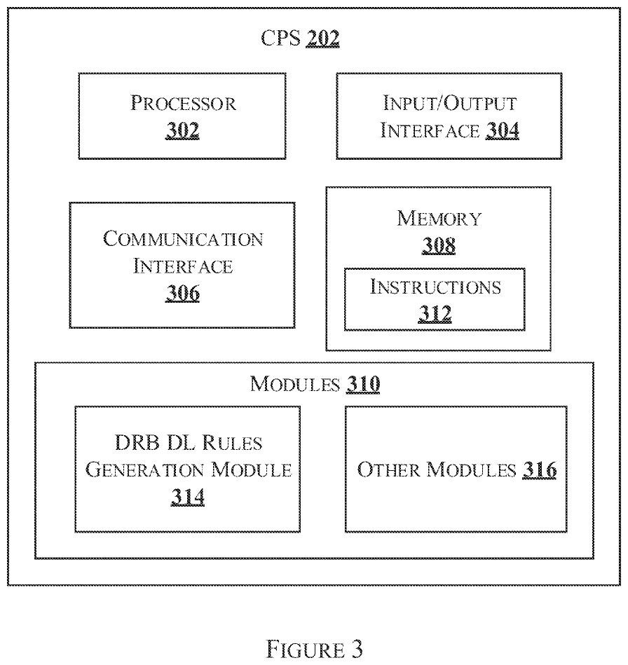

FIG. 3 illustrates an exemplary block diagram of CPS 202 for downlink routing management in accordance with an embodiment of the present disclosure.

The CPS 202 includes at least one processor 302 an Input/Output (I/O) interface 304, a communication interface 306, a memory 308 and a plurality of modules 310. The components of the CPS 202 provided herein are not exhaustive, and that the CPS 202 may include more or fewer components than that of depicted in FIG. 3. Further, two or more components may be embodied in one single component, and/or one component may be configured using multiple sub-components to achieve the desired functionalities. Some components of the CPS 202 may be configured using hardware elements, software elements, firmware elements and/or a combination thereof.

In one embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including, a Micro Controller Unit (MCU), a hardware accelerator, a special-purpose computer chip, or the like. In some embodiments, the user plane control module 208 may be the processor 302.

The I/O interface 304 may include mechanisms configured to receive inputs from and provide outputs to peripheral devices. For instance, the I/O interface 304 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a User Interface (UI) display (such as a light emitting diode display, a Thin-Film Transistor (TFT) display, a liquid crystal display, an active-matrix organic light-emitting diode (AMOLED) display, etc.), a speaker, a ringer, a vibrator, and the like.

In one embodiment, the communication interface 306 includes a transceiver for wirelessly communicating information to, or receiving information from, the UPS 204, the AMS 206, and the RAN DU 118 and one or more other network elements of the 5G communication architecture. The communication may be achieved over a communication network. The communication interface 306 may be dependent on one or more network entities communicating with the CPS 202. For example, the communication interface 306 may be N_{RC} interface when communicating with the UPS 204, may be one of N11 or N2 interface when communicating with the AMS 206 and may be F1-C interface when communicating with the RAN DU 118.

The memory 308 can be any type of storage accessible to the processor 302. For example, the memory 308 may include volatile or non-volatile memories, or a combination thereof. In an embodiment, the memory 308 stores a plurality of UE context associated with a plurality of UEs 112 anchored with the CPS 202. The memory 308 may also include instructions 312 to perform one or more methods of the CPS 202 as described in the present disclosure. In some embodiments, the instructions 312 may cause the processor 302 to perform one or more methods of the CPS 202.

The plurality of modules 310 may comprise, but not limited to, a DRB Down Link (DL) rules generation module 314, and other modules 316. In some embodiments, each of the plurality of modules 310 may be configured as one or more of a software module, a hardware module or a firmware module or a combination of any of these modules. In some embodiments, the plurality of modules 310 may be configured within the processor 302.

The DRB DL rules generation module 314 may be configured to generate one or more rules to classify one or more IP packets arriving from the DN 108 as the downlink packets addressed to the UE 112. The DRB DL rules generation module 314 may initially detect that a PDU session has been established for the UE 112. The DRB DL rules generation module 314 may generate a session establishment request comprising one or more rules to route downlink packets from the DN 108 to the UE 112. In one embodiment, the session establishment request may be a PFCP session establishment request as specified in 3GPP 29.244 standards. The DRB DL rules generation module 314 may generate a first Information Element (IE) indicating one or more downlink packet detection rules. The first information element may comprise one or more data to create a Packet Detection Rule (PDR) in the UPS 204 to classify one or more IP packets received from the DN 108 addressed to the UE 112 as downlink packets.

The DRB DL rules generation module 314 may be configured to generate a plurality of Forward Action Rules (FARs) to forward and/or take one or more actions on the downlink packets. The DRB DL rules generation module 314 may generate a second IE to create the plurality of FARs, corresponding to the PDR, to route the downlink packets from the UPS 204 to the UE 112 through a DRB. The second IE may be similar to “Create FAR” Information Element (IE) within the PFCP session establishment request but it includes additional information to enable forwarding of the data through a DRB. The additional information in the second IE is specified hereafter. The second IE may further comprise one or more IEs for creating the plurality of FARs within the UPS 204. The one or more IEs may comprise a security indication indicating user plane integrity protection and confidentiality protection for routing the downlink packets to the UE 112. The security indication may be present within the second IE in N_{RC} interface when installing the plurality of FARs for forwarding downlink packets. In some embodiments, the security indication may be similar to Security Indication IE as specified in 3GPP Technical Specification (TS) 37.483 clause 9.3.1.23.

The one or more IEs may further comprise a set of forwarding parameters indicating one or more forwarding instructions to be applied by the UPS 204 when an “Apply Action” IE requests the IP packets to be forwarded. The set of forwarding parameters may comprise, but not limited to, a destination interface, an outer header creation, a DRB Identifier (ID), PDCP configuration, SDAP configuration, PDCP Sequence Number (SN) information.

The destination interface identifies a destination interface of the one or more IP packets. The destination interface exists on the N_{RC} interface which indicates “0” for downlink packets forwarding and “2” for uplink forwarding. The value “0” indicates forwarding the downlink packets in an access channel assigned to the UE 112. The value “2” indicates forwarding the uplink IP packets through S/Gi-Local Area Network (LAN) or N6-LAN interface to the DN 108. The S/Gi-LAN is a service gateway interface between an Evolved Packet Core (EPC) network and Public IP network. The N6-LAN is an interface between the UPS 204 and any external networks or service platforms such as, the DN 108.

The outer header creation indicates adding one or more outer headers to each of the downlink packets. The outer header creation may contain the Fully qualified Tunnel Endpoint Identifier (F-TEID) of the remote GTP-U peer when adding a GTP-U/UDP/IP header, or the Destination IP address and/or Port Number when adding a UDP/IP header or an IP header or the Customer (C)-TAG/Service (S)-TAG (for 5GC).

The DRB identifier and the PDCP configuration may be present on the N_{RC} interface when creating the plurality of FARs for downlink routing. In some embodiments, the PDCP configuration may be similar to PDCP Configuration IE as specified in 3GPP TS 37.483 clause 9.3.1.38. In some embodiments, the DRB ID may be similar to DRB ID IE as specified in 3GPP TS 37.483 clause 9.3.1.16. The SDAP configuration may be present on the N_{RC} interface when creating the plurality of FARs for downlink routing and the UE is connected to Next Generation Core network (NG-Core). In some embodiments, the SDAP configuration may be similar to SDAP Configuration IE in 3GPP TS 37.483 clause 9.3.1.39.

The PDCP SN information may be present on the N_{RC} when creating plurality of FARs for the UE 112 while the UE 112 may be moving across one or more PDCP corresponding nodes. The PDCP corresponding node may be defined as a RAN node interacting with another RAN node hosting NR PDCP for flow control as specified in 3GPP 38.425 standard. In some embodiments, the PDCP SN status information may be similar to PDCP SN Status Information IE as specified in 3GPP TS 37.483 clause 9.3.1.58. Further, when the one or more of the PDCP configuration and the SDAP configuration IEs are present, the DRB configuration module Outer Header Creation shall be applied after the PDCP and SDAP encapsulation. The Outer Header Creation may utilize GTP-U extension headers specified in 3GPP TS 38.425 in this case.

In some embodiments, the second information element may further comprise a destination interface type. The destination interface type indicates a 3GPP interface type of the destination interface, if required by functionalities in the UPS 204 for e.g., for performance measurements. The 3GPP interface type may further include at least an interface type value indicating a type of destination interface for forwarding the downlink packets to the UE 112. The interface type value may indicate F1U interface. For example, the interface type value may be “32” indicating the F1U interface. This indicates forwarding the downlink packets to the UE 112 through the F1U interface unlike GTP-U tunnel routing, thus avoiding routing through the GTP-U tunneling.

The DRB DL rules generation module 314 may also be configured to generate a third IE indicating security information that may be present on the N_{RC} interface. The security information may carry one or more RAN user plane keys. In some embodiments, the security information may be similar to the security information as specified in 3GPP TS 37.483 clause 9.3.1.10. In some embodiments, the DRB DL rules generation module 314 may generate the third IE.

The DRB DL rules generation module 314 may be configured to generate a fourth IE to create a Usage Reporting Rule (URR) associated with the PDR. The URR may comprise a user plane inactivity timer also referred herein as DRB inactivity timer. The DRB inactivity timer may comprise a duration of an inactivity period after which the UPS 204 may generate a user plane inactivity report and send the user plane inactivity report. The DRB inactivity timer may facilitate the CPS 202 to determine when no user plane IP packets are received for the PFCP session for a duration exceeding the user plane inactivity timer. In some embodiments, the DRB inactivity timer may be similar to DRB inactivity timer specified in 3GPP TS 37.483 Clause 9.3.3.2.

The DRB DL rules generation module 314 may be configured to generate a fifth IE to create the plurality of QERs, to enforce on the downlink packets, corresponding to the PDR. The fifth IE may comprise one or more of RAN-level QoS flow parameters for routing the downlink packets. The one or more RAN-level QoS flow parameters may comprise choice QoS characteristics, Next Generation (NG)-RAN allocation and retention priority, guaranteed bit rate (GBR) QoS flow information, addition QoS flow information, and Reflective QoS flow to DRB mapping Indication (RDI). The one or more QoS flow parameters may be used to carry RAN level QoS information. In some embodiments, the one or more QoS flow parameters may be similar to one or more of QoS Flow Level QoS Parameters IE and sub-IEs specified in 3GPP TS 37.483 clause 9.3.1.26.

The other modules 316 may comprise a transmission module that may be configured to transmit the PFCP session establishment request to the UPS 204.

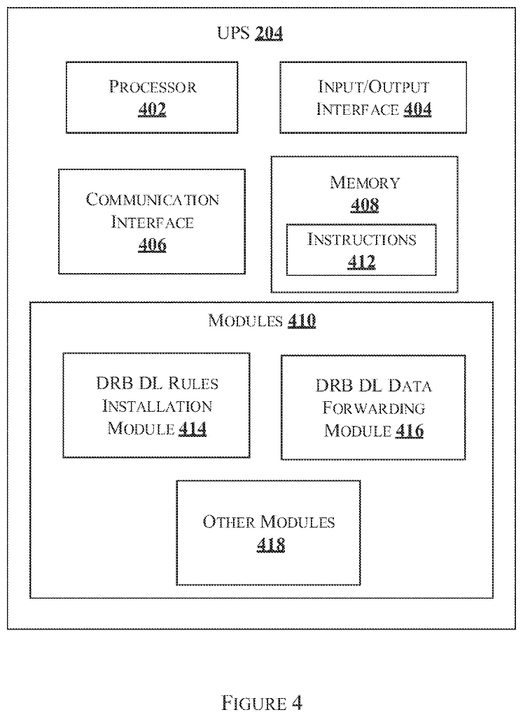

FIG. 4 illustrates an exemplary block diagram of the UPS 204 for downlink routing management, in accordance with an embodiment of the present disclosure.

The UPS 204 may include at least one processor 402 communicably coupled to an Input/Output (I/O) interface 404, a communication interface 406, a memory 408 and a plurality of modules 410. The components of the UPS 204 provided herein are not exhaustive, and that the UPS 204 may include more or fewer components than depicted in FIG. 4. Further, two or more components may be embodied in one single component, and/or one component may be configured using multiple sub-components to achieve the desired functionalities. Some components of the UPS 204 may be configured using hardware elements, software elements, firmware elements and/or a combination thereof.

In one embodiment, the processor 402 may be embodied as a multi-core processor, a single core processor, or a combination of one or more multi-core processors and one or more single core processors. For example, the processor 402 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The I/O interface 404 may include mechanisms configured to receive inputs from and provide outputs to peripheral devices. For instance, the I/O interface 404 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a Thin-Film Transistor (TFT) display, a liquid crystal display, an active-matrix organic light-emitting diode (AMOLED) display, etc.), a speaker, a ringer, a vibrator, and the like.

In one embodiment, the communication interface 406 includes a transceiver for wirelessly communicating information to, or receiving information from, the CPS 202, and the RAN DU 118 and one or more other network elements of the 4G communication architecture. The communication may be achieved over a communication network. The communication interface 406 may be dependent on one or more network entities communicating with the UPS 204. For example, the communication interface 406 may be N_{RC} interface when communicating with the CPS 202 and may be one of F1-U interface or UDP over IPv6 interface when communicating with the RAN DU 118.

The memory 408 can be any type of storage accessible to the processor 402. For example, the memory 408 may include volatile or non-volatile memories, or a combination thereof. In an embodiment, the memory 408 stores the one or more packet detection rules and forwarding rules and buffered downlink data. The memory 408 may also include instructions 412 to perform one or more methods of the UPS 204 as described in the present disclosure. In some embodiments, the instructions 412 may cause the processor 402 to perform one or more methods of the UPS 204.

The plurality of modules 410 may comprise, but not limited to, a DRB DL rules Installation module 414, a DRB DL data forwarding module 416 and other modules 418. In some embodiments, each of the plurality of modules 410 may be configured as one or more of a software module, a hardware module or a firmware module or a combination of any of these modules. In some embodiments, the plurality of modules 410 may be configured within the processor 402.

The DRB DL rules installation module 414 may be configured to receive the PFCP session establishment request from the CPS 202 through the N_{RC} interface and install one or more rules for routing the downlink IP packets. The PFCP session establishment request may create a PFCP session context in the UPS 204. The PFCP session context may comprise one or more IEs such as, but not limited to, the first IE, the second IE, the third IE, the fourth IE and the fifth IE. The first IE may comprise one or more data to create a Packet Detection Rule (PDR) to classify one or more IP packets received from a data network addressed to the UE as downlink packets. The second IE may indicate one or more data to create the plurality of FARs, corresponding to the PDR, to route the downlink packets from the UPS 204 to the UE 112 through the DRB.

The second IE may further comprise one or more IEs for creating the plurality of FARs within the UPS 204. The one or more IEs may comprise a security indication indicating user plane integrity protection and confidentiality protection for routing the downlink packets to the UE 112. The one or more IEs may further comprise a set of forwarding parameters indicating one or more forwarding instructions to be applied by the UPS 204 when an “Apply Action” IE requests the IP packets to be forwarded. The set of forwarding parameters may comprise, but not limited to, the destination interface, the outer header creation, the DRB Identifier (ID), the PDCP configuration, the SDAP configuration, the PDCP Sequence Number (SN) information.

The third IE may indicate security information that may carry one or more RAN user plane keys. The fourth IE may include information to create a Usage Reporting Rule (URR) associated with the PDR. The URR may comprise the DRB inactivity timer. The fifth IE may comprise one or more of RAN-level QoS flow parameters for routing the downlink packets. The one or more RAN-level QoS flow parameters may comprise choice QoS characteristics, Next Generation (NG)-RAN allocation and retention priority, Guaranteed Bit Rate (GBR) QoS flow information, addition QoS flow information, and Reflective QoS flow to DRB mapping Indication (RDI). The one or more QoS flow parameters may be used to carry RAN level QoS information.

The DRB DL rules installation module 414 may be configured to install one or more rules including, but not limited to, the PDR, the plurality of FARs, the URR and the plurality of QERs. The DRB DL data forwarding module 416 may be configured to forward the downlink packets to the UE 112 based on the one or more PDRs, the plurality of FARs, the one or more URRs and the plurality of QERs. The DRB DL data forwarding module 416 may receive one or more IP packets addressed to the UE 112 from the DN 108. The DRB DL data forwarding module 416 may classify that the one or more IP packets are downlink packets addressed to the UE 112. The DRB DL data forwarding module 416 may determine that there is no GTP-U tunnel allocated to forward the downlink packets and may buffer the downlink packets.

Furthermore, the DRB DL data forwarding module 416 may be configured to encapsulate the downlink packets using at least one of the second information element, and the third information element corresponding to the PDR. In one embodiment, the DRB DL data forwarding module 416 may forward the encapsulated downlink packets to the DRB identified by the DRB identifier. In one embodiment, the DRB DL data forwarding module 416 may include one or more of the PDCP configuration and the SDAP configuration in the downlink packets. In another embodiment, the DRB DL data forwarding module 416 may cipher the downlink packets using the one or more user plane keys comprised in the security information of the second IE. In yet another embodiment, the DRB DL data forwarding module 416 may perform integrity protection on the downlink packets using the security indication provided in the second IE.

Furthermore, the DRB DL data forwarding module 416 may be configured to forward the encapsulated downlink packets to the UE 112 through the DRB based on the plurality of FARs, and the plurality of QERs associated with the one or more PDRs. The DRB DL data forwarding module 416 may perform charging for the UE 112 using the URRs. In one embodiment, the DRB DL data forwarding module 416 may enforce the plurality of QERs on the encapsulated downlink packets. In another embodiment, the DRB DL data forwarding module 416 may enforce one or more RAN-level QoS flow parameters including choice QoS characteristics, Next Generation (NG)-RAN allocation and retention priority, guaranteed bit rate (GBR) QoS flow information, addition QoS flow information, and reflective QoS flow to DRB mapping indication (RDI). In yet another embodiment, the DRB DL data forwarding module 416 may forward the downlink packets to the destination interface specified in “the destination interface type”. In a further embodiment, the DRB DL data forwarding module 416 may detect inactivity in the DRB periodically at every time period indicated by the DRB inactivity timer.

Thus, the architecture 200 provides efficient and reliable low latency services to the UE 112 by collocating the SMF 104 and the RAN CU-CP 114 in the CPS 202 closer to the UE 112. Further, the architecture 200 provides methods and systems to directly bind the downlink data addressed to the UE 112 to one or more RAN radio bearer by routing the downlink data to the RAN DU 118 without tunnelling the downlink data through the GTP-U tunnels. Hence, such a direct binding of the downlink data through the radio bearers from the UPS 204 may facilitate to use service function chaining using IP headers themselves in mid-haul.

Further, the architecture 200 also provides a single interface N_{RC} to interact with the CPS 202. This helps to address the problem of cross-functional spillage that occurs when the UPS 204 interacts with SMF 104 and RAN CU-CP 114 separately. Also, the architecture 200 allows native IP routeing, thereby removing the need for special 3GPP GTP-U tunnelling devices thus, reducing the cost of the 3GPP architecture. As the downlink data arriving from the DN 108 is directly forwarded to the RAN DU 118 without adding any overhead required for GTP-U tunnelling, the architecture 200 reduces the overhead required for the GTP-U tunnelling while forwarding the downlink data.

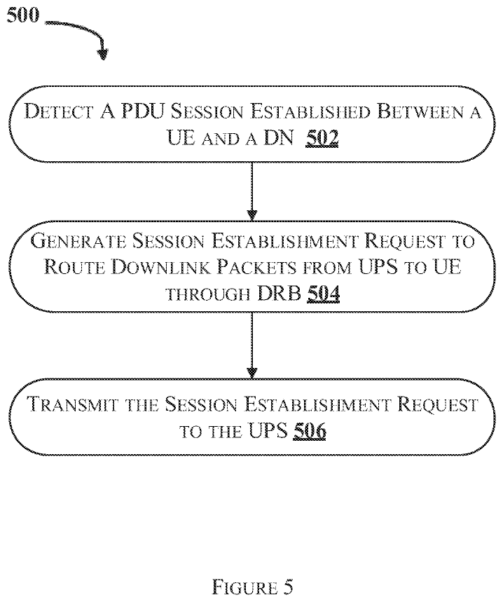

FIG. 5 illustrates an exemplary flowchart of a method for downlink routing management performed by the CPS 202 in accordance with another embodiment of the present disclosure.

The method 500 may be described in the general context of computer executable instructions. Generally, computer executable instructions can include routines, programs, objects, components, data structures, procedures, modules, and functions, which perform specific functions or implement specific abstract data types. The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 502, the CPS 202 may detect a PDU Session established between the UE 112 and the DN 108.

At block 504, the CPS 202 may generate a session establishment request to route downlink packets from the UPS 204 to the UE 112 through a DRB. The session establishment request may establish a Packet Forwarding Control Protocol (PFCP) session context in the UPS 204. The session establishment request may comprise a first IE and a second IE. The first IE may enable creating a PDR in the UPS 204, to classify one or more IP packets received from the DN 108 addressed to the UE 112 as downlink packets. The second IE may enable creating a plurality of FARs corresponding to the PDR in the UPS 204. The plurality of FARs may route the downlink packets from the UPS 204 to the UE 112 through the DRB.

At block 506, the CPS 202 may transmit the session establishment request to the UPS 204 to facilitate the UPS 204 to route the downlink packets to the UE 112.

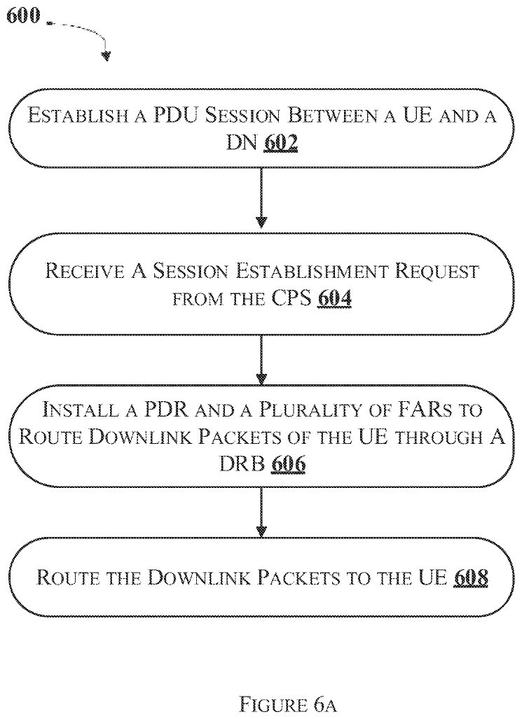

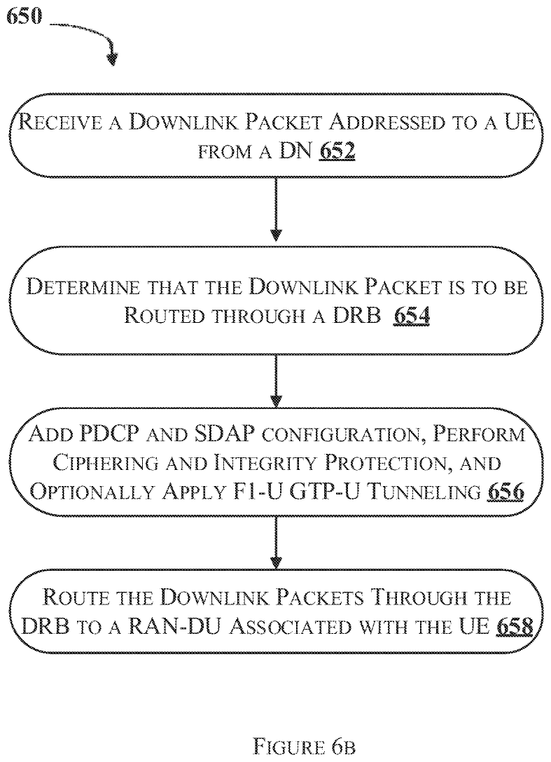

FIG. 6a illustrates an exemplary flowchart of a method for downlink routing management performed by the UPS 204 in accordance with another embodiment of the present disclosure.

The method 600 may be described in the general context of computer executable instructions. Generally, computer executable instructions can include routines, programs, objects, components, data structures, procedures, modules, and functions, which perform specific functions or implement specific abstract data types. The order in which the method 600 is described is not intended to be construed as a limitation, and any number of the method blocks described can be combined in any order to implement the method. Additionally, individual blocks may be deleted from the methods without departing from the scope of the subject matter described herein. Furthermore, the method can be implemented in any suitable hardware, software, firmware, or combination thereof.

At block 602, the UPS 204 may establish a PDU session between the UE 112 and the DN 108.

At block 604, the UPS 204 may receive a session establishment request from the CPS 202 in response to the establishment.

At block 606, the UPS 204 may install a PDR using a first IE and a plurality of FARs, corresponding to the PDR, using a second IE. The PDR may enable the UPS 204 to classify one or more IP packets received from the DN 108 addressed to the UE 112 as downlink packets. The plurality of FARs may enable the UPS 204 to route the downlink packets from the UPS 204 to the UE 112 through the DRB.

At block 608, the UPS 204 may route the downlink packets to the UE 112.

FIG. 6b illustrates an exemplary flowchart of a method for downlink routing management performed by the UPS 204 in accordance with another embodiment of the present disclosure.

At block 652, the UPS 204 may receive a downlink packet addressed to the UE 112 from the DN 108.

At block 654, the UPS 204 may determine that the downlink packet needs to be routed through a DRB upon matching the downlink packet with one or more PDRs received from the CPS 202.

At block 656, the UPS 204 may add PDCP and SDAP configuration, perform ciphering and integrity protection, and may optionally apply F1-U GTP-U tunneling on the downlink packet.

At block 658, the UPS 204 may route the downlink packet through the DRB to a RAN-DU 118 associated with the UE 112.

### Methods and Systems for Uplink Routing

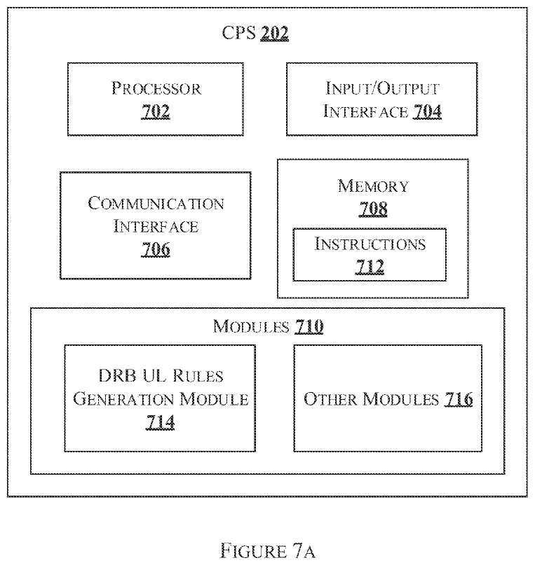

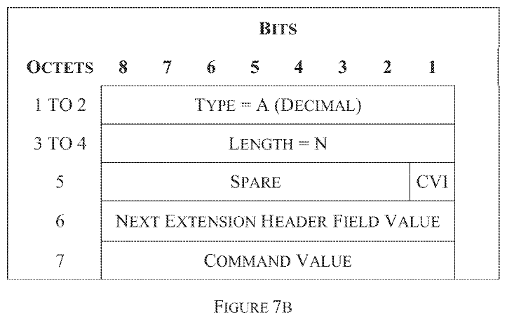

FIG. 7 illustrates an exemplary block diagram of CPS 202 for uplink routing management in accordance with an embodiment of the present disclosure.

The CPS 202 may include, without liming to, at least one processor 702, an Input/Output (I/O) interface 704, a communication interface 706, a memory 708 and a plurality of modules 710. The components of the CPS 202 provided herein are not exhaustive, and that the CPS 202 may include more or fewer components than that of depicted in FIG. 7. Further, two or more components may be embodied in one single component, and/or one component may be configured using multiple sub-components to achieve the desired functionalities. Some components of the CPS 202 may be configured using hardware elements, software elements, firmware elements and/or a combination thereof.

In one embodiment, the processor 702 may be embodied as a multi-core processor, a single core processor, or a combination of one or more multi-core processors and one or more single core processors. For example, the processor 702 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. In some embodiments, the user plane control module 208 may be the processor 702.

The I/O interface 704 may include mechanisms configured to receive inputs from and provide outputs to peripheral devices. For instance, the I/O interface 704 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a User Interface (UI) display (such as a light emitting diode display, a Thin-Film Transistor (TFT) display, a liquid crystal display, an active-matrix organic light-emitting diode (AMOLED) display, etc.), a speaker, a ringer, a vibrator, and the like.

In one embodiment, the communication interface 706 includes a transceiver for wirelessly communicating information to, or receiving information from, the UPS 204, the AMS 206, and the RAN DU 118 and one or more other network elements of the 5G communication architecture. The communication may be achieved over a communication network. The communication interface 706 may be dependent on one or more network entities communicating the CPS 202. For example, the communication interface 706 may be N_{RC} interface when communicating with the UPS 204, may be N11 or N2 interface when communicating with the AMS 206 and may be F1-C interface when communicating with the RAN DU 118.

The memory 708 can be any type of storage accessible to the processor 702. For example, the memory 708 may include volatile or non-volatile memories, or a combination thereof. In an embodiment, the memory 708 stores a plurality of UE context associated with a plurality of UEs 112 anchored with the CPS 202. The memory 708 may also include instructions 712 to perform one or more methods of the CPS 202 as described in the present disclosure. In some embodiments, the instructions 712 may cause the processor 702 to perform one or more methods of the CPS 202.

The plurality of modules 710 may comprise, but not limited to, a DRB Up Link (UL) rules generation module 714, and other modules 716. In some embodiments, each of the plurality of modules 710 may be configured as one or more of a software module, a hardware module or a firmware module or a combination of any of these modules. In some embodiments, the plurality of modules 710 may be configured within the processor 702.

The DRB UL rules generation module 714 may also be configured to generate one or more rules to classify one or more uplink packets arriving from the RAN DU 118 as one or more uplink data packets using a first IE or one or more uplink control packets using a second IE. The DRB UL rules generation module 714 may initially detect that a PDU session has been established for the UE 112. The DRB UL rules generation module 714 may generate a session establishment request comprising one or more rules to route the one or more uplink packets from the RAN DU 118 based on the classification. In one embodiment, the session establishment request may be a PFCP session establishment request as specified in 3GPP 29.244 standards. The DRB UL rules generation module 714 may generate a first IE to enable the UPS 204 to classify one or more uplink packets as one or more uplink data packets.

In one embodiment, the first IE may enable the UPS 204 to classify the one or more uplink packets, such as, but not limited to, one or more IP packets received from the RAN DU 118 as one or more uplink data packets. The first IE may comprise a classification rule indicating determining a presence of tunneling header comprising a tunneling identifier within the one or more uplink packets. The first IE may further comprise classifying the one or more uplink packets as one or more uplink data packets upon determining the presence of the tunneling identifier within the one or more uplink packets. The tunneling identifier may be an F-TEID.

In another embodiment, the second IE may comprise a classification rule to classify the one or more uplink packets, such as, but not limited to, one or more flow control messages arriving from the RAN DU 118 as one or more uplink control packets. The second IE may comprise a classification rule indicating determining a tunneling extension header of specific types.

The second IE may be defined as Packet Detection Information (PDI). The PDI may indicate one or more values against which one or more uplink packets may be matched. In some embodiments, the second IE may be defined as “PDI” IE within the “Create PDR” IE as specified in 3GPP TS 29.244 standards. The PDI may comprise the F-TEID, which may enable detecting one or more uplink packets comprising F-TEID as the one or more uplink data packets. The PDI may enable detecting a type of each of the uplink control packets based on a type of the GTP-U extension header in each of the uplink control packets. The PDI may comprise, but not limited to, a data element defined as a GTP-U extension header and command.

FIG. 7b illustrates a format for the GTP-U extension header and command for uplink routing management in accordance with an embodiment of the present disclosure.

The GTP-U extension header and command may not be present if a Traffic Endpoint ID is present. The GTP-U extension header and command may identify the GTP-U extension header type to match for one or more uplink data packets to classify the one or more uplink packets as uplink control packets. In some embodiments, the GTP-U extension header and command value data element may be specified in the format as shown in FIG. 7b.

The GTP-U extension header and command value data element may be used to encode the GTP-U extension header and the specific command to match. The data element may comprise a Command Value Indicator (CVI), a Next Extension Header Field Value, and a command value. The Next Extension Header Field Value may comprise a valid GTP-U extension header value as defined in 3GPP TS 29.281. The GTP-U extension header may be of one or more types comprising, but not limited to, a User Datagram Protocol (UDP) port, a PDCP PDU number, a long PDCP PDU number, a service class indicator, a RAN container, an Xw RAN container, an NR RAN container and a PDU session container. The CVI indicator bit may specify if the Command Value field is present or not present. When the command value is present, the command value may comprise a PDU type or a command value specific to the GTP-U extension header. For example, when the GTP-U extension header is a PDU session container, the CV indicates one or more PDU types. The one or more PDU types may be one of a Downlink (DL) user data, DL Data Delivery Status, or assistance information. In some embodiments, the one or more types of the GTP-U extension header may be as specified in 3GPP TS 38.425 standards.

Thus, the GTP-U extension header and command may enable matching GTP-U extension header of the one or more uplink control packets with one or more of the GTP-U extension header types and identify a type of the uplink control packet based on the matching. For example, the GTP-U extension header and command may enable detecting an uplink control packet comprising a GTP-U extension header type of PDU session container and matches the uplink control packet with the one or more PDU types. In this example, the GTP-U extension header and command may detect that the uplink control packet is a Downlink Data Delivery Status (DDDS) packet.

The DRB UL rules generation module 714 may generate a third IE to remove an outer header from the one or more uplink data packets and/or the one or more uplink control packets arriving from the RAN DU 118. The third IE may be defined as an outer header removal that indicates removal of one or more outer headers from the one or more uplink packets classified based on the PDR. In some embodiments, the third IE may be defined as “Outer Header Removal” IE within the “Create PDR” IE as specified in 3GPP TS 29.244 standards. The outer header removal may comprise one or more data elements. The one or more data elements may be at least one of an outer header removal description, a GTP-U extension header deletion and one or more octets when specified explicitly. The outer header removal description may indicate removal of one or more of the PDCP header and the SDAP header from the one or more uplink data packets. This requires the UPS 204 to decipher the uplink data packet which has been ciphered by the PDCP at the UE 112. The GTP-U extension header deletion may indicate deletion of GTP-U extension header from the one or more uplink control packets. The data element GTP-U extension header deletion may indicate that GTP-U extension header of at least a New Radio-User Plane (NR-U) container needs to be deleted. The NR-U container may be as specified in 3GPP TS 48.425 standards. Upon removing the outer header, the one or more uplink data packets may be referred to as one or more deciphered data packets or one or more decapsulated data packets.

Further, the DRB UL rules generation module 714 may be further configured to generate a fourth IE indicating an FAR Identifier (ID) corresponding to the PDR. In some embodiments, the fourth IE may be FAR ID included in the “Create PDR” IE as specified in 3GPP TS 29.244 standards. The DRB UL rules generation module 714 may generate the FAR ID indicating forwarding action rules for the one or more uplink data packets and forwarding action rules for the one or more uplink control packets.

The forwarding action rules for the one or more uplink data packets may comprise, but not limited to, forwarding the decapsulated uplink data packets using a destination interface type embedded in a fifth IE. The destination interface type identifies a destination interface for forwarding the one or more uplink data packets. The destination interface exists on the N_{RC} interface which indicates “0” for downlink packets forwarding and “2” for uplink forwarding. The value “0” indicates forwarding the downlink packets in an access channel assigned to the UE 112. The value “2” indicates forwarding the uplink data packets through S/Gi-LAN or N6-LAN interface to the DN 108. Thus, the FAR ID for the one or more uplink data packets indicates forwarding the decapsulated data packets to the DN 108.

Alternatively, the forwarding and action rules for the uplink control packets may comprise, but not limited to forwarding or taking action based on the one or more predefined rules associated with the type of each uplink control packet identified by the command value. The fifth IE may comprise determining one or more predefined rules associated with the type of uplink control packet. For example, there may be a first set of predefined rules for a DDDS command and a second set of predefined rules for DL user data. In this example, the first set of predefined rules may indicate upon deleting the GTP-U extension header from the DDDS command and forwarding the DDDS command to the CPS 202.

Further, the DRB UL rules generation module 714 may further generate one or more other IEs such as URR ID, QER ID, activate predefined rules, activation time, deactivation time, UE IP address pool identity, transport delay reporting and Radio Access Technology (RAT) type to be transmitted in the session establishment request on the N_{RC} interface. In some embodiments, the one or more other IEs may be defined as specified in 3GPP TS 29.244. In some other embodiments, the PDI may comprise, but not limited to, a local F-TEID.

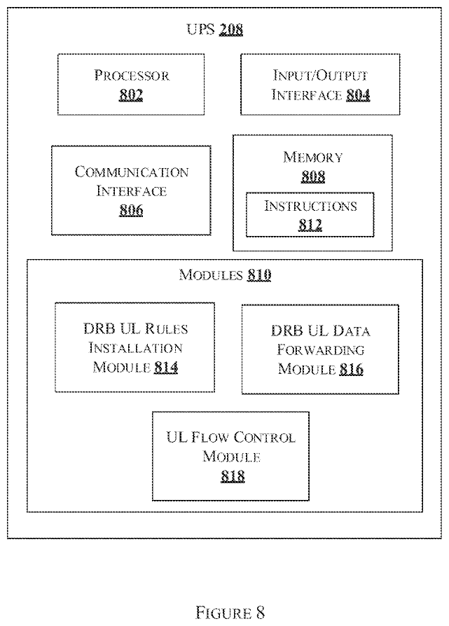

FIG. 8 illustrates an exemplary block diagram of the UPS 204 for uplink routing management, in accordance with an embodiment of the present disclosure.

The UPS 204 includes at least one processor 802 communicably coupled to, an Input/Output (I/O) interface 804, a communication interface 806, a memory 808 and a plurality of modules 810. The components of the UPS 204 provided herein are not exhaustive, and that the UPS 204 may include more or fewer components than that of depicted in FIG. 8. Further, two or more components may be embodied in one single component, and/or one component may be configured using multiple sub-components to achieve the desired functionalities. Some components of the UPS 204 may be configured using hardware elements, software elements, firmware elements and/or a combination thereof.

In one embodiment, the processor 802 may be embodied as a multi-core processor, a single core processor, or a combination of one or more multi-core processors and one or more single core processors. For example, the processor 802 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The I/O interface 804 may include mechanisms configured to receive inputs from and provide outputs to peripheral devices. For instance, the I/O interface 804 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a Thin-Film Transistor (TFT) display, a liquid crystal display, an active-matrix organic light-emitting diode (AMOLED) display, etc.), a speaker, a ringer, a vibrator, and the like.

In one embodiment, the communication interface 806 includes a transceiver for wirelessly communicating information to, or receiving information from, the CPS 202, and the RAN DU 118 and one or more other network elements of the 8G communication architecture. The communication may be achieved over a communication network. The communication interface 806 may be dependent on one or more network entities communicating with the UPS 204. For example, the communication interface 806 may be N_{RC} interface when communicating with the CPS 202 and may be one of F1-U interface or UDP over IPv6 interface when communicating with the RAN DU 118.

The memory 808 can be any type of storage accessible to the processor 802. For example, the memory 808 may include volatile or non-volatile memories, or a combination thereof. In an embodiment, the memory 808 stores the one or more packet detection rules and forwarding rules and buffered downlink data. The memory 808 may also include instructions 812 to perform one or more methods of the UPS 204 as described in the present disclosure. In some embodiments, the instructions 812 may cause the processor 802 to perform one or more methods of the UPS 204.

The plurality of modules 810 may comprise, but not limited to, a DRB UL rules installation module 814, a DRB UL data forwarding module 816 and a UL flow control module 818. In some embodiments, each of the plurality of modules 810 may be configured as one or more of a software module, a hardware module or a firmware module or a combination of any of these modules. In some embodiments, the plurality of modules 810 may be configured within the processor 302.

The DRB UL rules installation module 814 may be configured to receive the PFCP session establishment request from the CPS 202 through the N_{RC} interface and install one or more rules for routing the one or more uplink packets. The PFCP session establishment request may create a PFCP session context for the uplink routing in the UPS 204. The PFCP session context may comprise one or more IEs such as, but not limited to, the first IE, the second IE, the third IE, the fourth IE and the fifth IE. The first IE may comprise one or more data to create a Packet Detection Rule (PDR) to classify one or more uplink packets, such as, but not limited to, one or more IP packets received from the RAN DU 118 as one or more uplink data packets. The classification may be based on a detection of an F-TEID, also referred herein as a tunneling identifier, associated with the one or more uplink packets. The second IE may comprise one or more data to create a Packet Detection Rule (PDR) to classify one or more uplink packets, received from the RAN DU 118 as one or more uplink control packets. The one or more uplink packets may be, but not limited to, one or more flow control messages.

In one embodiment, the first IE may enable the UPS 204 to classify the one or more uplink packets, such as, but not limited to, one or more IP packets received from the RAN DU 118 as one or more uplink data packets. The first IE may comprise a classification rule indicating determining a presence of tunneling header comprising a tunneling identifier within the one or more uplink packets. The first IE may further comprise classifying the one or more uplink packets as one or more uplink data packets upon determining the presence of the tunneling identifier within the one or more uplink packets. The tunneling identifier may be an F-TEID.

In another embodiment, the second IE may comprise a classification rule to classify the one or more uplink packets, such as, but not limited to, one or more flow control messages arriving from the RAN DU 118 as one or more uplink control packets. The second IE may comprise a classification rule indicating determining a tunneling extension header of specific types.

The second IE may enable removing an outer header from the one or more uplink data packets arriving from the RAN DU 118. The second IE may be defined as an outer header removal that indicates removal of one or more outer headers from the one or more uplink data packets classified. In some embodiments, the second IE may be defined as “Outer Header Removal” IE within the “Create PDR” IE as specified in 3GPP TS 29.244 standards. The outer header removal may comprise one or more data elements. The one or more data elements may be at least one of an outer header removal description, a GTP-U extension header deletion and one or more octets when specified explicitly. The outer header removal description may indicate removal of one or more of the PDCP header and the SDAP header from the one or more uplink data packets. This requires the UPS 204 to decipher the uplink data packet that has been ciphered using PDCP at the UE 112. The GTP-U extension header deletion may indicate deletion of GTP-U extension header from the one or more uplink data packets. The data element GTP-U extension header deletion may indicate that GTP-U extension header of at least a New Radio-User Plane (NR-U) container needs to be deleted. The NR-U container may be as specified in 3GPP TS 48.425 standards. Upon removal of the outer header, the one or more uplink data packets may be referred to as decapsulated data packets or PDCP deciphered data packets.

The second IE may be defined as Packet Detection Information (PDI). The PDI may indicate one or more values against which one or more uplink packets may be matched. In some embodiments, the third IE may be defined as “PDI” IE within the “Create PDR” IE as specified in 3GPP TS 29.244 standards. The PDI may comprise the F-TEID, which may enable detecting one or more uplink packets comprising F-TEID as the one or more uplink data packets. The PDI may enable detecting a type of each of the uplink control packets based on a type of the GTP-U extension header in each of the uplink control packets. The PDI may comprise, but not limited to, a data element defined as a GTP-U extension header and command.

In some embodiments, the PDI may enable detecting a type of each of the one or more uplink control packets based on the type of the GTP-U extension header in each of the one or more uplink control packets. The PDI may comprise, but not limited to, a data element defined as a GTP-U extension header and command. The GTP-U extension header and command may not be present if a Traffic Endpoint ID is present. The GTP-U extension header and command may identify the GTP-U extension header type to match for one or more uplink packets to classify the one or more uplink packets as one or more uplink control packets.

In some embodiments, the GTP-U extension header and command value data element may be specified in the format illustrated in FIG. 7b. The GTP-U extension header and command value data element may be used to encode the GTP-U extension header and the specific command to match. The data element may comprise a Command Value Indicator (CVI), a Next Extension Header Field Value, and a command value. The Next Extension Header Field Value may comprise a valid GTP-U extension header value as defined in 3GPP TS 29.281. The GTP-U extension header may be of one or more types such as, but not limited to, a User Datagram Protocol (UDP) port, a PDCP PDU number, a long PDCP PDU number, a service class indicator, a RAN container, an Xw RAN container, an NR RAN container and a PDU session container. The CVI indicator bit may specify if the Command Value field is present or not present. When the command value is present, the command value may comprise a PDU type or a command value specific to the GTP-U extension header. For example, when the GTP-U extension header is a PDU session container, the CV indicates one or more PDU types. The one or more PDU types may be one of a Downlink (DL) user data, DL Data Delivery Status, or assistance information. In some embodiments, the one or more types of the GTP-U extension header may be as specified in 3GPP TS 38.425 standards.

Thus, the GTP-U extension header and command may enable the UPS 204 to match one or more uplink control packets comprising at least one of the GTP-U header types and identify a type of the uplink control packet based on the matching. For example, the GTP-U extension header and command may enable detecting an uplink control packet comprising a GTP-U extension header type of PDU session container and matches the uplink control packet with the one or more PDU types. Further, the GTP-U extension header and command may detect that the uplink control packet is a DDDS packet. In other examples, the GTP-U extension header and command may enable detecting other types of uplink control packets as described herein.

Further, the fourth IE may indicate a FAR Identifier (ID) corresponding to the PDR. In some embodiments, the fourth IE may be FAR ID included in the “Create PDR” IE as specified in 3GPP TS 29.244 standards. The FAR ID may indicate one or more forwarding action rules for the one or more decapsulated data packets and one or more forwarding action rules for the one or more uplink control packets.

The forwarding action rules for the one or more decapsulated data packets may comprise, but not limited to, forwarding the decapsulated data packets using a destination interface type embedded in a fifth IE. The fifth IE may be the destination interface for the one or more decapsulated packets. The destination interface type identifies a destination interface for forwarding the one or more decapsulated data packets. The destination interface exists on the N_{RC} interface which indicates “0” for downlink packets forwarding and “2” for uplink forwarding. The value “0” indicates forwarding the downlink packets in an access channel assigned to the UE 112. The value “2” indicates forwarding the decapsulated data packets through S/Gi-LAN or N6-LAN interface to the DN 108. Thus, the FAR ID for the uplink data packets indicates forwarding the decapsulated data packets to the DN 108.

Alternatively, the forwarding and action rules for the one or more uplink control packets may comprise, but not limited to forwarding or taking action based on the one or more predefined rules associated with the type of each uplink control packet identified by the command value. For example, there may be a first set of predefined rules for a DDDS command and a second set of predefined rules for DL user data.

The session establishment request may also comprise, but not limited to, one or more other IEs such as URR ID, QER ID, activate predefined rules, activation time, deactivation time, UE IP address pool identity, transport delay reporting and RAT type to be transmitted in the session establishment request on the N_{RC} interface. In some embodiments, the one or more other IEs may be defined as specified in 3GPP TS 29.244.

The DRB UL rules installation module 814 may be configured to install one or more rules such as, but not limited to the PDR to classify the one or more uplink packets and one or more FARs to forward or take action on the one or more uplink packets. In some embodiments, the DRB UL rules installation module 814 may also install one or more other rules, that are defined in 3GPP TS 29.244.

The DRB UL data forwarding module 816 may be configured to forward the one or more uplink packets based on the one or more rules installed. The DRB UL data forwarding module 816 may receive one or more uplink packets arriving at the UPS 204 from the RAN DU 118 and may classify the one or more uplink packets as one or more uplink data packets based on the PDR. In some embodiments, the DRB UL data forwarding module 816 may detect one or more uplink packets that comprise an F-TEID as one or more uplink data. Further, the DRB UL data forwarding module 816 may be configured to remove the tunneling extension header if the tunneling extension header is a NR-RAN container, and one or more of the PDCP header and the SDAP header from each of the one or more uplink data packets. Thereafter, the DRB UL data forwarding module 816 may be configured to forward the one or more uplink data packets to the DN 108 through the destination interface as defined in the fifth IE.

In some embodiments, the UL flow control module 818 may detect one or more uplink packets that comprise specific types of GTP-U extension header as one or more uplink control packets. The UL flow control module 818 may be configured to detect the type of the one or more uplink packets based on the type of the tunnelling extension header. Further, the DRB UL data forwarding module 816 may be configured to match one or more predefined rules for the detected type of the tunnelling extension header. Accordingly, the UL flow control module 818 may be configured to apply the one or more predefined rules for routing the one or more uplink control packets from the UPS 204 based on the one or more predefined rules. The one or more predefined rules for performing one or more flow control algorithms may be implemented in the UPS 204. This provides the CPS 202 with flexibility to select a specific flow control implementation for the F1-U interface. Thus, the UL flow control module 818 may identify an FAR specified by the FAR ID to forward or take action on the uplink control packets based on the one or more predefined rules associated with the type of each uplink control packet identified by the command value. For example, there may be a first set of predefined rules for a DDDS command and a second set of predefined rules for DL user data. In some embodiments, the DRB UL data forwarding module 814 may forward the uplink packets towards the DN 108 without any tunnel, such as, but not limited to, through the N6-LAN interface.

Thus, the uplink routing management according to the present disclosure enables different pre-defined rules for performing different flow control algorithms in the UPS 204. Such flexibility may enable the UPS 204 to select a specific flow control implementation for the F1-U interface. Furthermore, the uplink routing management has been enhanced to detect uplink data packets arriving on a DRB and subsequently forward the uplink data packets to the DN 108. Further, the uplink routing management according to the present disclosure enables routing of the uplink data packets without tunnelling thereby reducing overhead required for routing the uplink data packets.

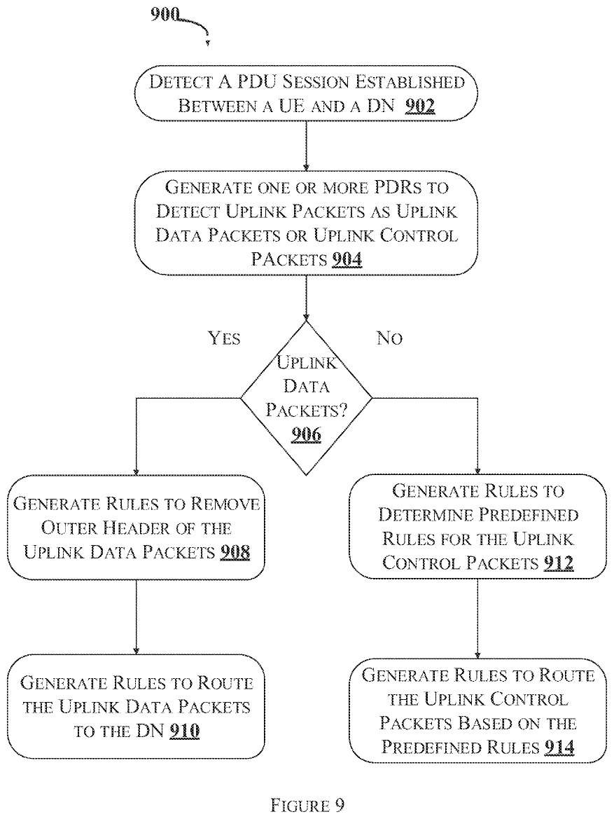

FIG. 9 illustrates an exemplary flowchart of a method for uplink routing management performed by the CPS 202 in accordance with another embodiment of the present disclosure.

The method 900 may be described in the general context of computer executable instructions. Generally, computer executable instructions can include routines, programs, objects, components, data structures, procedures, modules, and functions, which perform specific functions or implement specific abstract data types. The order in which the method 900 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 902, the CPS 202 may detect a PDU session established between the UE 112 and the DN 108.

At block 904, the CPS 202 may generate a session establishment request to route one or more uplink packets from the RAN DU 118 to the UPS 204. The session establishment request may establish a Packet Forwarding Control Protocol (PFCP) session context in the UPS 204. The session establishment request may comprise a first IE and a second IE to create a PDR in the UPS 204 to classify one or more uplink packets, received from the RAN DU 118 as one or more uplink data packets of one or more uplink control packets. The first IE may comprise a classification rule to classify one or more uplink packets, comprising a TEID, received through a DRB as one or more uplink data packets. The second IE may enable creating a PDR in the UPS 204, to classify one or more uplink packets, comprising a tunneling extension header or based on a type of tunneling extension header, as one or more uplink control packets.

At block 906, the CPS 202 may determine whether to generate rules for one or more uplink data packets or for one or more uplink control packets. The CPS 202 may proceed to block 908 to generate rules for one or more uplink data packets and may proceed to block 912 to generate rules for one or more uplink control packets.

At block 908, the CPS 202 may generate a third IE comprising rules to remove outer header of the one or more uplink data packets.

At block 910, the CPS 202 may generate rules to route the one or more uplink data packets to the DN 108.

At block 912, the CPS 202 may generate a fourth IE comprising rules to determine one or more predefined rules for the uplink control packets.

At block 914, the CPS 202 may generate rules to route the one or more uplink control packets based on the predefined rules.

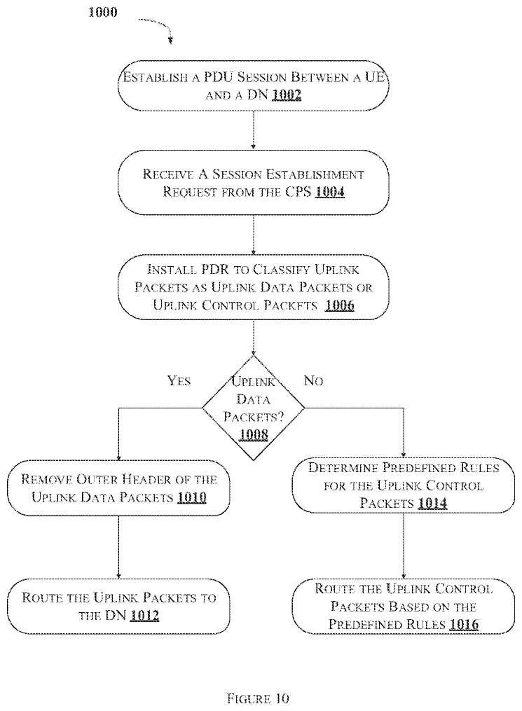

FIG. 10 illustrates an exemplary flowchart of a method for uplink routing management performed by the UPS 204 in accordance with another embodiment of the present disclosure.

The method 1000 may be described in the general context of computer executable instructions. Generally, computer executable instructions can include routines, programs, objects, components, data structures, procedures, modules, and functions, which perform specific functions or implement specific abstract data types. The order in which the method 1000 is described is not intended to be construed as a limitation, and any number of the method blocks described can be combined in any order to implement the method. Additionally, individual blocks may be deleted from the methods without departing from the scope of the subject matter described herein. Furthermore, the method can be implemented in any suitable hardware, software, firmware, or combination thereof.

At block 1002, the UPS 204 may establish a PDU session between the UE 112 and the DN 108.

At block 1004, the UPS 204 may receive a session establishment request from the CPS 202 in response to the establishment.

At block 1006, the UPS 204 may install one or more PDRs using a first IE and a second IE to classify one or more uplink packets, received from the RAN DU 118, as one or more uplink data packets or one or more uplink control packets. A first PDR may enable the UPS 204 to classify one or more uplink packets, comprising a TEID, received through a DRB as one or more uplink data packets. A second PDR may enable the UPS 204 to classify one or more uplink packets, comprising a tunneling extension header or based on a type of the tunneling extension header, as one or more uplink control packets. Upon installing the one or more PDRs, the UPS 204 may detect and may classify the one or more uplink packets as one or more uplink data packets or one or more uplink control packets.

At block 1008, the UPS 204 may determine if a current uplink packet is an uplink data packet or an uplink control packet. The UPS 204 may proceed to block 1010 if the current uplink packet is uplink data packet and may proceed to block 1014 if the current uplink packet is uplink control packet.

At block 1010, the UPS 204 may remove outer header of the uplink data packet using a third IE. The UPS 204 may remove one or more of the PDCP header and the SDAP header from the uplink data packet to generate a decapsulated data packet.

At block 1012, the UPS 204 may route the decapsulated data packet to the DN 108.

At block 1014, the UPS 204 may determine one or more predefined rules for the one or more uplink control packets using a fourth IE.

At block 1016, the UPS 204 may route the one or more uplink control packets based on the one or more predefined rules.

The methods disclosed with reference to FIGS. 5-6 and 9-10, or one or more operations of the CPS 202, and the UPS 204 explained with reference to FIGS. 2-4 and 7-8 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

[Clause 1] In an aspect, a control plane system of a Radio Access Network (RAN) node is disclosed. The control plane system is configured to detect a Protocol Data Unit (PDU) session established between a User Equipment (UE) and a Data Network (DN). The control plane system is configured to generate a session establishment request, based on the detection, to establish a Packet Forwarding Control Protocol (PFCP) session context in a user plane system. The session establishment request comprising a first information element to create a Packet Detection Rule (PDR) to classify one or more IP packets received from the DN addressed to the UE as downlink packets and a second information element to create a plurality of Forward Action Rules (FARs) corresponding to the PDR to route the downlink packets from the user plane system to the UE through a Data Radio Bearer (DRB). The control plane system is further configured to transmit the session establishment request to the user plane system to facilitate the user plane system to route the downlink packets to the UE.

[Clause 2] In an aspect, the session establishment request of clause 1 further comprises a third information element indicating security data including one or more Radio Access Network (RAN) user plane keys.

[Clause 3] In an aspect, the session establishment request of clauses 1 or 2 further comprises a fourth information element to create a Usage Reporting Rule (URR) associated with the PDR, wherein the URR comprises a user plane inactivity timer indicating a time period to detect inactivity in the DRB.

[Clause 4] In an aspect, the second information element of any of the clauses 1 to 3, comprises a security indication indicating user plane integrity protection and confidentiality protection for routing the downlink packets to the UE.

[Clause 5] In an aspect, the second information element of any of the clauses 1 to 4, comprises a plurality of forwarding parameters for routing the downlink packets through the Data Radio Bearer (DRB) based on one or more of a DRB identifier of the DRB, Packet Data Convergence Protocol (PDCP) configuration data, Service Data Adaptation Protocol (SDAP) configuration data and PDCP Sequence Number (SN).

[Clause 6] In an aspect, the session establishment request of any of the clauses 1 to 5, further comprises a fifth information element to create Quality of Service (QoS) Enforcement Rules (QERs) corresponding to the PDR to route the downlink packets through the DRB. The fifth information element includes one or more of RAN-level QoS flow parameters for routing the downlink packets, wherein the one or more RAN-level QoS flow parameters including choice QoS characteristics, Next Generation (NG)-RAN allocation and retention priority, guaranteed bit rate (GBR) QoS flow information, addition QoS flow information, and Reflective QoS flow to DRB mapping Indication (RDI).

[Clause 7] In an aspect, the control plane system of any of the clauses 1 to 6 is configured to transmit the session establishment request through a network interface that is configured to communicate using PFCP.

[Clause 8] In an aspect, a user plane system of a RAN node is disclosed. The user plane system is configured to establish a Protocol Data Unit (PDU) session between a User Equipment (UE) and a Data Network (DN). The user plane system is configured to receive a session establishment request from a control plane system in response to the establishment. The user plane system is configured to install a Packet Detection Rule (PDR) to classify one or more IP packets as downlink packets received from the DN addressed to the UE using a first information element in the session establishment request and install a plurality of Forward Action Rules (FARs) corresponding to the PDR using a second information element in the session establishment request to route the downlink packets through a Data Radio Bearer (DRB). The user plane system is configured to route the downlink packets to the UE.

[Clause 9] In an aspect, the user plane system, of the clause 8, is further configured to establish a Packet Forwarding Control Protocol (PFCP) session context in the user plane system in response to receiving the session establishment request. The session establishment request further comprises a third information element indicating security data including one or more Radio Access Network (RAN) user plane keys.

[Clause 10] In an aspect, the user plane system, of any of the clauses 8 or 9, is configured to detect inactivity in the DRB using a fourth information element in the session establishment request. The fourth information element comprises creating a Usage Reporting Rule (URR) associated with the PDR. The URR comprises a user plane inactivity timer indicating a time period to detect inactivity in the DRB.

[Clause 11] In an aspect, the user plane system, of any of the clauses 8-10, is further configured to use a security indication, indicating user plane integrity protection and confidentiality protection associated with a Protocol Data Unit (PDU) session for routing the downlink packets to the UE, embedded in the second information element.

[Clause 12] In an aspect, the user plane system, of any of the clauses 8-11, is further configured to use a plurality of routing rules for routing the downlink packets through the DRB based on one or more routing parameters embedded in the second information element. The one or more routing parameters comprise a DRB identifier of the DRB, Packet Data Convergence Protocol (PDCP) configuration data, Service Data Adaptation Protocol (SDAP) configuration data and PDCP Sequence Number (SN) data.

[Clause 13] In an aspect, the user plane system, of any of the clauses 8-12, is further configured to use a plurality of Quality of Service (QoS) Enforcement Rules (QERs) corresponding to the PDR using a fifth information element in the session establishment request to route the downlink packets through the DRB. The fifth information element indicates enforcing one or more of RAN-level QoS flow parameters for routing the downlink packets. The one or more RAN-level QoS flow parameters including choice QoS characteristics, Next Generation (NG)-RAN allocation and retention priority, guaranteed bit rate (GBR) QoS flow information, addition QoS flow information, and reflective QoS flow to DRB mapping indication (RDI).

[Clause 14] In an aspect, the user plane system, of any of the clauses 8-13, is configured to receive the session establishment request through a network interface configured to communicate with the control plane system using PFCP.

[Clause 15] In an aspect, to route the downlink packets to the UE through the DRB, the user plane system, of any of the clauses 8-14, is configured to receive one or more IP packets addressed to the UE from the DN and classify the one or more IP packets as downlink packets based on the PDR. The user plane system is configured to buffer the downlink packets and encapsulate the downlink packets using the second information element, and the third information element corresponding to the PDR. The user plane system is further configured to forward the encapsulated downlink packets to the UE through the DRB based on at least one of the plurality of FARs, the URR and at least one of the plurality of QERs associated with the PDR.

[Clause 16] In an aspect, a method performed by a control plane system of a Radio Access Network (RAN) node is disclosed. The method comprises detecting a Protocol Data Unit (PDU) session established between a User Equipment (UE) and a Data Network (DN). The method comprises generating a session establishment request, based on the detection, to establish a Packet Forwarding Control Protocol (PFCP) session context in a user plane system. The session establishment request comprising a first information element to create a Packet Detection Rule (PDR) to classify one or more IP packets received from the DN addressed to the UE as downlink packets and a second information element to create a plurality of Forward Action Rules (FARs) corresponding to the PDR to route the downlink packets from the user plane system to the UE through a Data Radio Bearer (DRB). The method further comprises transmitting the session establishment request to the user plane system to facilitate the user plane system to route the downlink packets to the UE.

[Clause 17] In an aspect, a method performed by a user plane system of a RAN node is disclosed. The method comprises establishing a Protocol Data Unit (PDU) session between a User Equipment (UE) and a Data Network (DN). The method comprises receiving a session establishment request from a control plane system in response to the establishment. The method comprises installing a Packet Detection Rule (PDR) to classify one or more IP packets as downlink packets received from the DN addressed to the UE using a first information element in the session establishment request and installing a plurality of Forward Action Rules (FARs) corresponding to the PDR using a second information element in the session establishment request to route the downlink packets through a Data Radio Bearer (DRB). The method comprises routing the downlink packets to the UE.

[Clause 18] In an aspect, a non-transitory computer-readable medium having program instructions stored thereon, executed by a control plane system of a RAN node is disclosed. The program instructions may comprise detecting a Protocol Data Unit (PDU) session established between a User Equipment (UE) and a Data Network (DN). The program instructions may comprise generating a session establishment request, based on the detection, to establish a Packet Forwarding Control Protocol (PFCP) session context in a user plane system. The session establishment request comprising a first information element to create a Packet Detection Rule (PDR) to classify one or more IP packets received from the DN addressed to the UE as downlink packets and a second information element to create a plurality of Forward Action Rules (FARs) corresponding to the PDR to route the downlink packets from the user plane system to the UE through a Data Radio Bearer (DRB). The program instructions may further comprise transmitting the session establishment request to the user plane system to facilitate the user plane system to route the downlink packets to the UE.

[Clause 19] In an aspect, a non-transitory computer-readable medium having program instructions stored thereon, executed by a user plane system of a RAN node is disclosed. The program instructions may comprise establishing a Protocol Data Unit (PDU) session between a User Equipment (UE) and a Data Network (DN). The program instructions may comprise receiving a session establishment request from a control plane system in response to the establishment. The program instructions may comprise installing a Packet Detection Rule (PDR) to classify one or more IP packets as downlink packets received from the DN addressed to the UE using a first information element in the session establishment request and installing a plurality of Forward Action Rules (FARs) corresponding to the PDR using a second information element in the session establishment request to route the downlink packets through a Data Radio Bearer (DRB). The program instructions may comprise routing the downlink packets to the UE.

[Clause 20] In an aspect, a control plane system of a Radio Access Network (RAN) node is disclosed. The control plane system is configured to detect a Protocol Data Unit (PDU) session established between a User Equipment (UE) and a Data Network (DN). The control plane system is configured to generate a session establishment request, based on the detection, to establish a Packet Forwarding Control Protocol (PFCP) session context in a user plane system. The session establishment request comprising a first information element to create a Packet Detection Rule (PDR) to classify one or more uplink packets received from a Radio Access Network (RAN) Distributed Unit (DU) as one of one or more uplink data packets and a second information element to classify one or more uplink packets as one or more uplink control packets. Further, the session establishment request comprises a third information element to remove an outer header of the one or more uplink data packets, wherein the outer header comprises at least a tunnelling extension header, a Packet Data Convergence Protocol (PDCP) header, and a Service Data Adaptation Protocol (SDAP) header. The session establishment request also comprises one or more rules to route the one or more uplink data packets to the DN. Further, the session establishment request comprises a fourth information element to determine one or more predefined rules associated with the one or more uplink control packets. The session establishment request also comprises one or more rules to route the one or more uplink control packets based on the one or more predefined rulesThe control plane system is further configured to transmit the session establishment request to the user plane system to facilitate the user plane system to route the one or more uplink packets.

[Clause 21] In an aspect, the control plane system, of clause 20, wherein the first information element indicates classifying the one or more uplink packets as one or more uplink data packets upon determining a presence of tunneling identifier within a tunneling header of the one or more uplink packets and the second information element indicates classifying the one or more uplink packets as the one or more uplink control packets upon determining one or more types of a tunneling extension header.

[Clause 22] In an aspect, the control plane system, of clauses 20 or 21, wherein tunnelling header is a General Packet Radio Service (GPRS) Tunnelling Protocol User Plane (GTP-U) header and wherein the tunneling identifier is a Fully qualified Tunnel Endpoint Identifier (F-TEID) and wherein the tunneling extension header is a GTP-U extension header.

[Clause 23] In an aspect, the control plane system, of any of the clauses 20 to 22, wherein the tunneling extension header is a New Radio-User plane (NR-U) container.

[Clause 24] In an aspect, the control plane system, of any of the clauses 20 to 23, wherein the second information element comprises at least a command value indicator indicating a presence of a command value, when the command value indicator is enabled for an uplink control packet and an absence of the command value when the command value indicator is disabled for the uplink control packet, a next extension header field value indicating a type of tunnelling extension header and a command value indicating a type of data included in the uplink control packets.

[Clause 25] In an aspect, the control plane system, of any of the clauses 20 to 24, the control plane system is further configured to transmit the session establishment request through a network interface that is configured to communicate using Packet Forwarding Control Protocol (PFCP).

[Clause 26] In an aspect, the control plane system, of any of the clauses 20 to 25, is configured to generate a fifth information element in the session establishment request indicating a destination interface to route the one or more uplink data packets based on one or more FARs associated with the PDR, wherein the destination interface is configured to route the uplink packets to the DN.

[Clause 27] In an aspect, the user plane system of a Radio Access Network (RAN) node is disclosed. The user plane system configured to establish a Protocol Data Unit (PDU) session between a User Equipment (UE) and a Data Network (DN) and receive a session establishment request from the control plane system in response to the establishment. The user plane system is configured to install a Packet Detection Rule (PDR) to classify one or more IP packets received from a Radio Access Network (RAN) Distributed Unit (DU) as one of one or more uplink data packets using a first information element received in the session establishment request or one or more uplink control packets using a second information element received in the session establishment request. The user plane system is further configured to remove an outer header of the one or more uplink data packets using a third information element received in the session establishment request. The outer header comprises at least a tunnelling extension header, a Packet Data Convergence Protocol (PDCP) header, and a Service Data Adaptation Protocol (SDAP) header. The user plane system is further configured to route the one or more uplink data packets to the DN. The user plane system is also configured to determine one or more predefined rules associated with the one or more uplink control packets using a fourth information element in the session establishment request and route the one or more uplink control packets based on the one or more predefined rules.

[Clause 28] In an aspect, the user plane system of clause 27, wherein the first information element indicates classifying the one or more uplink packets as one or more uplink data packets upon determining a presence of tunneling identifier within a tunneling header of the one or more uplink packets and the second information element indicates classifying the one or more uplink packets as the one or more uplink control packets upon determining one or more types of a tunneling extension header.

[Clause 29] In an aspect, the user plane system of clauses 27 or 28, wherein the tunnelling header is a General Packet Radio Service (GPRS) Tunnelling Protocol User Plane (GTP-U) header and wherein the tunneling identifier is a Fully qualified Tunnel Endpoint Identifier (F-TEID) and wherein the tunneling extension header is a GTP-U extension header.

[Clause 30] In an aspect, the user plane system, of any of the clauses 27 to 29, wherein the tunneling extension header is a New Radio-User plane (NR-U) container.

[Clause 31] In an aspect, the user plane system, of any of the clauses 27 to 30, wherein the second information element comprises at least a command value indicator indicating a presence of a command value, when the command value indicator is enabled for an uplink control packet and an absence of the command value when the command value indicator is disabled for the uplink control packet, a next extension header field value indicating a type of tunnelling extension header and a command value indicating a type of data included in the uplink control packets.

[Clause 33] In an aspect, the user plane system, of any of the clauses 27 to 32, wherein the user plane system is configured to receive the session establishment request through a network interface that is configured to communicate using Packet Forwarding Control Protocol (PFCP).

[Clause 35] In an aspect, the user plane system, of any of the clauses 28 to 34, the user plane system is configured to route the one or more uplink data packets based on one or more FARs associated with the PDR, through a destination interface indicated in a fifth information element in the session establishment request, wherein the destination interface is configured to route the one or more uplink data packets to the DN.

[Clause 36] In an aspect, a method performed by a control plane system of a Radio Access Network (RAN) node is disclosed. The method comprises detecting a Protocol Data Unit (PDU) session established between a User Equipment (UE) and a Data Network (DN). The method comprises generating a session establishment request, based on the detection, to establish a Packet Forwarding Control Protocol (PFCP) session context in a user plane system. The session establishment request comprising a first information element to create a Packet Detection Rule (PDR) to classify one or more uplink packets received from a Radio Access Network (RAN) Distributed Unit (DU) as one of one or more uplink data packets and a second information element to classify one or more uplink packets as one or more uplink control packets. Further, the session establishment request comprises a third information element to remove an outer header of the one or more uplink data packets, wherein the outer header comprises at least a tunnelling extension header, a Packet Data Convergence Protocol (PDCP) header, and a Service Data Adaptation Protocol (SDAP) header. The session establishment request also comprises one or more rules to route the one or more uplink data packets to the DN. Further, the session establishment request comprises a fourth information element to determine one or more predefined rules associated with the one or more uplink control packets. The session establishment request also comprises one or more rules to route the one or more uplink control packets based on the one or more predefined rulesThe method comprises transmitting the session establishment request to the user plane system to facilitate the user plane system to route the uplink packets.

[Clause 37] In an aspect, a method performed by a user plane system of a RAN node is disclosed. The method comprises establishing a Protocol Data Unit (PDU) session between a User Equipment (UE) and a Data Network (DN) and receiving a session establishment request from the control plane system in response to the establishment. The method further comprises installing a Packet Detection Rule (PDR) to classify one or more IP packets received from a Radio Access Network (RAN) Distributed Unit (DU) as one of one or more uplink data packets using a first information element received in the session establishment request or one or more uplink control packets using a second information element received in the session establishment request. The method comprises removing an outer header of the one or more uplink data packets using a third information element received in the session establishment request. The outer header comprises at least a tunnelling extension header, a Packet Data Convergence Protocol (PDCP) header, and a Service Data Adaptation Protocol (SDAP) header. The method comprises routing the one or more uplink data packets to the DN. The method comprises determining one or more predefined rules associated with the one or more uplink control packets using a fourth information element in the session establishment request and routing the one or more uplink control packets based on the one or more predefined rules.

[Clause 38] In an aspect, a non-transitory computer-readable medium having program instructions stored thereon, executed by a control plane system of a RAN node is disclosed. The program instructions may comprise detecting a Protocol Data Unit (PDU) session established between a User Equipment (UE) and a Data Network (DN). The program instructions may comprise generating a session establishment request, based on the detection, to establish a Packet Forwarding Control Protocol (PFCP) session context in a user plane system. The session establishment request comprising a first information element to create a Packet Detection Rule (PDR) to classify one or more uplink packets received from a Radio Access Network (RAN) Distributed Unit (DU) as one of one or more uplink data packets and a second information element to classify one or more uplink packets as one or more uplink control packets. Further, the session establishment request comprises a third information element to remove an outer header of the one or more uplink data packets, wherein the outer header comprises at least a tunnelling extension header, a Packet Data Convergence Protocol (PDCP) header, and a Service Data Adaptation Protocol (SDAP) header. The session establishment request also comprises one or more rules to route the one or more uplink data packets to the DN. Further, the session establishment request comprises a fourth information element to determine one or more predefined rules associated with the one or more uplink control packets. The session establishment request also comprises one or more rules to route the one or more uplink control packets based on the one or more predefined rules. The program instructions may further comprise transmitting the session establishment request to the user plane system to facilitate the user plane system to route the uplink packets.

[Clause 39] In an aspect, a non-transitory computer-readable medium having program instructions stored thereon, executed by a user plane system of a RAN node is disclosed. The program instructions may comprise establishing a Protocol Data Unit (PDU) session between a User Equipment (UE) and a Data Network (DN). The program instructions may comprise receiving a session establishment request from the control plane system in response to the establishment. The program instructions may comprise installing a Packet Detection Rule (PDR) to classify one or more IP packets received from a Radio Access Network (RAN) Distributed Unit (DU) as one of one or more uplink data packets using a first information element received in the session establishment request or one or more uplink control packets using a second information element received in the session establishment request. The program instructions may comprise removing an outer header of the one or more uplink data packets using a third information element received in the session establishment request. The outer header comprises at least a tunnelling extension header, a Packet Data Convergence Protocol (PDCP) header, and a Service Data Adaptation Protocol (SDAP) header. The program instructions may comprise routing the one or more uplink data packets to the DN. The program instructions may comprise determining one or more predefined rules associated with the one or more uplink control packets using a fourth information element in the session establishment request and routing the one or more uplink control packets based on the one or more predefined rules.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternatives (including equivalents, extensions, variations, deviations, etc., of those described herein) will be apparent to persons skilled in the relevant art(s) based on the teachings contained herein. Such alternatives fall within the scope of the disclosed embodiments.

Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items or items. It must also be noted that as used herein and in the appended claims, the singular forms “a,” “an,” and “the” include plural references unless the context clearly dictates otherwise. Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

We claim:

1. A control plane system of a Radio Access Network (RAN) node, the control plane system is configured to:
detect a Protocol Data Unit (PDU) session established between a User Equipment (UE) and a Data Network (DN);
generate a session establishment request, based on the detection, to establish a Packet Forwarding Control Protocol (PFCP) session context in a user plane system, wherein the session establishment request comprising:
a first information element to create a Packet Detection Rule (PDR) to classify one or more IP packets received from the DN addressed to the UE as downlink packets; and
a second information element to create a plurality of Forward Action Rules (FARs) corresponding to the PDR to route the downlink packets from the user plane system to the UE through a Data Radio Bearer (DRB); and
transmit the session establishment request to the user plane system to facilitate the user plane system to route the downlink packets to the UE through the DRB.

2. The control plane system of claim 1, wherein the session establishment request further comprises a third information element indicating security data including one or more Radio Access Network (RAN) user plane keys and a fourth information element to create a Usage Reporting Rule (URR) associated with the PDR, wherein the URR comprises a user plane inactivity timer indicating a time period to detect inactivity in the DRB.

3. The control plane system of claim 1, wherein the second information element comprises:
a security indication indicating user plane integrity protection and confidentiality protection for routing the downlink packets to the UE; and
a plurality of forwarding parameters for routing the downlink packets through the Data Radio Bearer (DRB) based on one or more of:
a DRB identifier of the DRB;
Packet Data Convergence Protocol (PDCP) configuration data;
Service Data Adaptation Protocol (SDAP) configuration data; and
PDCP Sequence Number (SN).

4. The control plane system of claim 1, wherein the session establishment request further comprises a fifth information element to create Quality of Service (QoS) Enforcement Rules (QERs) corresponding to the PDR to route the downlink packets through the DRB, wherein the fifth information element including:
one or more RAN-level QoS flow parameters for routing the downlink packets, wherein the one or more RAN-level QoS flow parameters including choice QoS characteristics, Next Generation (NG)-RAN allocation and retention priority, guaranteed bit rate (GBR) QoS flow information, addition QoS flow information, and Reflective QoS flow to DRB mapping Indication (RDI).

5. The control plane system of claim 1, further configured to transmit the session establishment request through a network interface that is configured to communicate using PFCP.

6. A user plane system of a Radio Access Network (RAN) node, the user plane system is configured to:
establish a Protocol Data Unit (PDU) session between a User Equipment (UE) and a Data Network (DN);
receive a session establishment request from a control plane system in response to the establishment;
install a Packet Detection Rule (PDR) to classify one or more IP packets as downlink packets received from the DN addressed to the UE using a first information element received in the session establishment request;
install a plurality of Forward Action Rules (FARs) corresponding to the PDR using a second information element received in the session establishment request to route the downlink packets through a Data Radio Bearer (DRB); and
route the downlink packets to the UE through the DRB.

7. The user plane system of claim 6, further configured to:
establish a Packet Forwarding Control Protocol (PFCP) session context in the user plane system in response to receiving the session establishment request, wherein the session establishment request further comprises a third information element indicating security data including one or more Radio Access Network (RAN) user plane keys; and
detect inactivity in the DRB using a fourth information element in the session establishment request, wherein the fourth information element comprises creating a Usage Reporting Rule (URR) associated with the PDR, wherein the URR comprises a user plane inactivity timer indicating a time period to detect inactivity in the DRB.

8. The user plane system of claim 6, wherein in the plurality of FARs installed, the user plane system is configured to:
use a security indication, indicating user plane integrity protection and confidentiality protection associated with a Protocol Data Unit (PDU) session for routing the downlink packets to the UE, embedded in the second information element; and
use a plurality of routing rules for routing the downlink packets through the DRB based on one or more routing parameters embedded in the second information element, wherein the one or more routing parameters comprise:
a DRB identifier of the DRB;
Packet Data Convergence Protocol (PDCP) configuration data;
Service Data Adaptation Protocol (SDAP) configuration data; and
PDCP Sequence Number (SN) data.

9. The user plane system of claim 6, further configured to:
use a plurality of Quality of Service (QoS) Enforcement Rules (QERs) corresponding to the PDR using a fifth information element in the session establishment request to route the downlink packets through the DRB,
wherein the fifth information element indicating enforcing one or more of RAN-level QoS flow parameters for routing the downlink packets, wherein the one or more RAN-level QoS flow parameters including choice QoS characteristics, Next Generation (NG)-RAN allocation and retention priority, guaranteed bit rate (GBR) QoS flow information, addition QoS flow information, and reflective QoS flow to DRB mapping indication (RDI).

10. The user plane system of claim 6, further configured to receive the session establishment request through a network interface configured to communicate with the control plane system using PFCP.

11. The user plane system of claim 6, wherein to route the downlink packets to the UE through the DRB, the user plane system is further configured to:
receive one or more IP packets addressed to the UE from the DN;
classify the one or more IP packets as downlink packets based on the PDR;
buffer the downlink packets;
encapsulate the downlink packets using at least one of the second information element, and the third information element corresponding to the PDR; and
forward the encapsulated downlink packets to the UE through the DRB based on at least one of the plurality of FARs, the URR and at least one of the plurality of QERs associated with the PDR.

12. A user plane system of a Radio Access Network (RAN) node, the user plane system configured to:
establish a Protocol Data Unit (PDU) session between a User Equipment (UE) and a Data Network (DN);
receive a session establishment request from a control plane system in response to the establishment;
install a Packet Detection Rule (PDR) to classify one or more uplink packets received from a Radio Access Network (RAN) Distributed Unit (DU) as one of:
one or more uplink data packets using a first information element received in the session establishment request; or
one or more uplink control packets using a second information element received in the session establishment request;
for the one or more uplink data packets:
remove an outer header of the one or more uplink data packets, wherein the outer header comprises at least a tunnelling extension header, a Packet Data Convergence Protocol (PDCP) header, and a Service Data Adaptation Protocol (SDAP) header using a third information element received in the session establishment request; and
route the one or more uplink data packets to the DN; and
for the one or more uplink control packets:
determining one or more predefined rules associated with the one or more uplink control packets using a fourth information element in the session establishment request; and
route the one or more uplink control packets based on the one or more predefined rules.

13. The user plane system of claim 12, wherein the first information element indicates classifying the one or more uplink packets as one or more uplink data packets upon determining a presence of tunneling identifier within a tunneling header of the one or more uplink packets and the second information element indicates classifying the one or more uplink packets as the one or more uplink control packets upon determining one or more types of a tunneling extension header.

14. The user plane system of claim 13, wherein the tunnelling header is a General Packet Radio Service (GPRS) Tunnelling Protocol User Plane (GTP-U) header and wherein the tunneling identifier is a Fully qualified Tunnel Endpoint Identifier (F-TEID) and wherein the tunneling extension header is a GTP-U extension header.

15. The user plane system of claim 12, wherein the tunneling extension header is a New Radio-User plane (NR-U) container.

16. The user plane system of claim 15, wherein the second information element includes at least:
a command value indicator indicating a presence of a command value, when the command value indicator is enabled for an uplink control packet and an absence of the command value when the command value indicator is disabled for the uplink control packet;
a next extension header field value indicating a type of tunnelling extension header within the uplink control packet; and
a command value indicating a type of data included in the uplink control packets.

17. The user plane system of claim 12, further configured to receive the session establishment request through a network interface that is configured to communicate using Packet Forwarding Control Protocol (PFCP).

18. The user plane system of claim 12, further configured to route the one or more uplink data packets based on one or more FARs associated with the PDR, through a destination interface indicated in a fifth information element in the session establishment request, wherein the destination interface is configured to route the one or more uplink data packets to the DN.
